(19) United States
(12) Patent Application Publication
(10) Pub. No.: US 2006/0279957 A1
(43) Pub. Date: Dec. 14, 2006

(54) Lamp, lamp holder, power supply module, backlight assembly having the power supply module and display device having the power supply module

(75) Inventors: Yoon-Soo Kwon, Seoul (KR); Jung-Tae Kang, Suwon-si (KR); Sang-Hoon Park, Yongin-si (KR); Jin-Ho Ha, Suwon-si (KR); Woong-Jae Chang, Suwon-si (KR); Yong-Seok Yang, Asan-si (KR); Min-Ho Ok, Hwaseong-si (KR); Kyung-Rok Ko, Suwon-si (KR); Jae-Hwan Chun, Suwon-si (KR); Jae-Seok Gho, Cheonan-si (KR); Dal-Jung Kwon, Seoul (KR); Moon-Shik Kang, Seongnam-si (KR); Young-Sup Kwon, Seoul (KR); Eui-Dong Hwang, Inchon (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/450,559

(22) Filed: Jun. 9, 2006

(30) Foreign Application Priority Data
Jun. 9, 2005 (KR) 10-2005-0049336
Jun. 27, 2005 (KR) 10-2005-0055514
Aug. 24, 2005 (KR) 10-2005-0077803
Nov. 19, 2005 (KR) 10-2005-0111014
Nov. 19, 2005 (KR) 10-2005-0111013
Jan. 6, 2006 (KR) 10-2006-0001974
Feb. 10, 2006 (KR) 10-2006-0013091

(51) Int. Cl. F21V 15/00

(52) U.S. Cl. 362/378

(57) ABSTRACT

A lamp, lamp holder, and a power supply substrate that allow easy fabrication of a backlight assembly or a power supply module for a display device are presented. The lamp includes a lamp tube and an electrode that extends outside the lamp tube to form a lamp lead. The lamp holder includes a body for holding the lamp tube and a power supply member for providing voltage to the lamp lead. A power supply module includes a power supply substrate combined with a lamp holder holding the lamp. The lamp holders are fixed to fixing portions of the power supply substrate or to fixing holes of a connection plate. As the design allows easy separation of the lamp holders from the power supply substrate, building a backlight assembly or a display device is facilitated.

### CROSS-REFERENCE TO RELATED APPLICATIONS

This application claims priority under 35 USC §119 to Korean Patent Application No. 2005-49336 filed on Jun. 9, 2005, Korean Patent Application No. 2005-55514 filed on Jun. 27, 2005, Korean Patent Application No. 2005-77803 filed on Aug. 24, 2005, Korean Patent Application No. 2005-111013 filed on Nov. 19, 2005, Korean Patent Application No. 2005-111014 filed on Nov. 19, 2005, Korean Patent Application No. 2006-1974 filed on Jan. 6, 2006 and Korean Patent Application No. 2006-13091 filed on Feb. 10, 2006, the contents of which are incorporated herein by reference in their entirety.

### BACKGROUND OF THE INVENTION

1. Field of the Invention

The present invention relates to a lamp, a lamp holder, a power supply module, a backlight assembly having the power supply module and a display device having the backlight assembly. More particularly, the present invention relates to a lamp having a securing portion, a lamp holder easily assembled with the lamp, a power supply module having the lamp and the lamp holder, a backlight assembly having the power supply module, and a display device having the backlight assembly.

2. Description of the Related Art

Liquid crystal display (LCD) devices are thinner, lighter in weight, and more power efficient than other types of well-known display devices. Furthermore, LCD devices generally require a lower driving voltage than other display devices and produce images of a higher quality, similar to that of a cathode ray tube (CRT) device. As a result, LCD devices have been widely employed in various electronic devices.

The LCD devices are generally divided into transmissive LCD devices and reflective LCD devices. A transmissive LCD device displays images using backlight from a light source whereas a reflective LCD device displays images using ambient light. The reflective LCD device is usually employed in a small electronic device, such as an electronic clock or an electronic calculator that does not need significant power consumption to operate. The transmissive LCD device is generally used in a relatively large electronic device, such as a notebook computer, that displays an image with high quality.

In general, the transmissive LCD device having a display panel utilizes a backlight disposed behind the display panel as the external light source. Conventional backlight assemblies are typically divided into a direct illumination type backlight assemblies and edge-type backlight assemblies.

The direct illumination type backlight assembly includes a plurality of light sources disposed behind the display panel so that the light sources can directly provide light to the display panel. The edge-type backlight assembly includes a light source disposed at a side of a light-guide plate such that the light source can provide a display panel with light through the light-guide plate.

In the direct illumination type backlight assembly, cold cathode fluorescent lamps (CCFL) are commonly employed as the light sources. The direct illumination type backlight assembly includes lamp holders for fixing the lamps in position. The lamps are fixed to a bottom plate of a receiving container.

As the display panel of the display device has become larger, the backlight assembly has been developed to include one flat fluorescent lamp or a plurality of fluorescent lamps arranged in parallel. This parallel arrangement provides the display panel with uniform light at high luminance. The backlight assembly has also been developed to include lamp holders that receive electrodes of lamps so that the lamps are easily assembled with the lamp holders.

The lamp holders are advantageous in that they firmly fix the lamps to the bottom plate of the receiving container. However, the numbers of the lamps and lamp holders used in the backlight assembly increase with the size of the display panel, and a high number of lamps and lamp holders begins to pose disadvantages. For example, with many lamps and lamp holders, the display device becomes heavier and fabrication time lengthens.

In fabricating the backlight assembly, a voltage supply wire connected to an inverter is attached to the lamp holders by a soldering method or the lamp holders are connected to a printed circuit board (PCB) by a soldering method. The soldering step tends to increase the time for fabricating the backlight assembly and does not always securely attach the leads of the lamps to the lamp holders. Additionally, the lamps may be damaged during the soldering process. Furthermore, the connector between the lamp holders and the wire or the PCB may be broken in the operation of the backlight assembly.

A method of fabricating the backlight assembly without the above disadvantages of conventional soldering is desired.

### SUMMARY OF THE INVENTION

In one aspect, the present invention is a lamp which can be easily assembled with a lamp holder. The lamp includes a lamp tube, an electrode disposed at an end portion of the lamp tube, and a lamp lead. The lamp tube may be of a type that contains a discharging gas. The electrode is inside the lamp tube. The lamp lead includes a connection portion and a securing portion. The connection portion extends from the electrode to the securing portion, wherein the securing portion is located outside the lamp tube.

In another aspect, the present invention is a lamp holder that may be easily assembled with a lamp and a power supply substrate. The lamp holder includes a body and a power supply member. The body includes a lamp support portion capable of supporting an end portion of a lamp. The power supply member is fixed to the body and welded to a voltage supply wire for providing a voltage to an electrode that is disposed at the end portion of the lamp.

Alternatively, the lamp holder includes a body, a power supply member, and a conductive adhesion member. The body of the lamp holder includes a lamp support groove and a receiving space. The lamp support groove is formed at a surface of the body adjacent to the receiving space. The power supply member is disposed in the receiving space and has a power supply terminal exposed at one end and a connection terminal exposed at another end. The power supply terminal and the connection terminal are electrically coupled. The conductive adhesion member covers the power supply member.

As yet another alternative, the lamp holder has a body, a power supply member, and a holder cap. The body has a lamp support groove and a receiving space, wherein the lamp support groove is formed at a face of the body adjacent to the receiving space. The power supply member is disposed in the receiving space. The power supply member has a first connection terminal coupled to a second connection terminal, and each of the first and the second connection terminals is divided into two connection terminal portions. The four connection terminal portions are arranged to securely hold a lamp lead. The holder cap, which is inserted in the receiving space, connects the power supply member to the lamp lead by pressing the power supply member.

In yet another aspect, the present invention is a power supply module that lends itself to efficient fabrication. The power supply module includes a lamp holder and a power supply substrate. The lamp holder has a body and a power supply member, wherein the power supply member includes a connection terminal coupled to the body and a power supply terminal capable of coupling to a lamp. The power supply substrate makes contact with the connection terminal.

In yet another aspect, the present invention is a backlight assembly including the power supply module. The backlight assembly includes a receiving container, lamp holders, and a power supply substrate. The receiving container includes a plate with openings. The lamp holders are inserted into the openings, and each lamp holder is coupled to a lamp. Each lamp holder has a body and a power supply member. The power supply member has a connection terminal and a power supply terminal. The connection terminal is exposed on a first surface of the plate, and the power supply terminal is exposed on a second surface of the plate to hold an electrode of the lamp in place. The power supply substrate, which is disposed on the plate, includes a connection portion making contact with the connection terminal.

In yet anther aspect, the present invention is a display device including the power supply module. The display device includes a power supply substrate, a plurality of lamps, a voltage supply wire, and lamp holders. The power supply substrate provides a voltage. The lamps include lamp tubes and electrodes disposed at end portions of the lamp, wherein each of the electrodes extends to form a lamp lead. The voltage supply wire electrically connects the power supply substrate to the lamps in parallel. The lamp holders are coupled to the voltage supply wire. Each of the lamp holders has a body and a power supply member to which the voltage supply wire is welded. The body has a lamp support groove in which an end portion of one of the lamp tubes is disposed. The lamp lead couples one of the electrodes to the power supply member.

Alternatively, the display device includes a receiving container, a plurality of lamps, lamp holders, a power supply unit, and a display panel. The receiving container includes a plate with openings. The lamps are disposed on the plate, and have electrodes. The lamp holders are inserted into the openings. The lamp holders include connection terminals fixed to bodies of the lamp holders and exposed at a first surface of the plate. The lamp holders also include power supply terminals exposed at a second surface of the plate and coupled to the electrodes. The power supply unit includes fixing portions and connection portions, wherein the fixing portions are coupled to the lamp holders and the connection portions contact the connection terminals. The display panel is disposed on the lamps to display an image using light emitted by the lamps.

The invention enhances the electrical connections among the lamp, the lamp holder and the power supply substrate without using soldering, and allows easy fabrication of a backlight assembly or a power supply module including a lamp, a lamp holder and the power supply substrate.

The invention further improves the rework efficiency of the power supply module of the backlight assembly by allowing the power supply substrate to be separated from the power supply module or the backlight assembly without detaching the lamps from the lamp holders.

### BRIEF DESCRIPTION OF THE DRAWINGS

The above and other features and advantages of the present invention will become readily apparent by reference to the following detailed description when considered in conjunction with the accompanying drawings.

FIG. 1 is a perspective view illustrating a lamp and a lamp holder in accordance with an embodiment of the present invention;

FIG. 2 is a plan view illustrating the lamp and the lamp holder in FIG. 1;

FIG. 3 is a cross-sectional view illustrating the lamp taken along the line I-I′ in FIG. 1;

FIG. 4 is a plan view illustrating a lamp and a lamp holder in accordance with an embodiment of the present invention;

FIG. 5 is a perspective view illustrating a lamp holder in accordance with an embodiment of the present invention;

FIG. 6 is a perspective view illustrating a lamp and a lamp holder in accordance with an embodiment of the present invention;

FIG. 7 is a perspective view illustrating a lamp and a lamp holder in accordance with an embodiment of the present invention;

FIG. 8 is an exploded perspective view illustrating the lamp and the lamp holder in FIG. 7;

FIG. 9 is a cross-sectional view illustrating the lamp and the lamp holder taken along the line II-II′ in FIG. 7;

FIG. 10 is an exploded perspective view illustrating a lamp and a lamp holder in accordance with an embodiment of the present invention;

FIG. 11 is a cross-sectional view illustrating the lamp and the lamp holder taken along the line III-III′ in FIG. 10;

FIG. 12 is a cross-sectional view illustrating the lamp and the lamp holder taken along the line IV-IV′ in FIG. 10;

FIG. 13 is a top perspective view illustrating a power supply module in accordance with an embodiment of the present invention;

FIG. 14 is a bottom perspective view illustrating the power supply module in FIG. 13;

FIG. 15 is an exploded view illustrating the power supply module in FIG. 13;

FIG. 16 is a perspective view illustrating a lamp holder in accordance with an embodiment of the present invention;

FIG. 17 is a cross-sectional view illustrating the power supply module taken along the line V-V′ in FIG. 13;

FIG. 18 is a cross-sectional view illustrating a power supply module in accordance with an embodiment of the present invention;

FIG. 19 is a cross-sectional view illustrating a power supply module in accordance with an embodiment of the present invention;

FIG. 20 is a partially cut perspective view illustrating a power supply module in accordance with an embodiment of the present invention;

FIG. 21 is a perspective view illustrating a power supply module in accordance with an embodiment of the present invention;

FIG. 22 is an exploded perspective view illustrating the power supply module in FIG. 21;

FIG. 23 is a perspective view illustrating a lamp holder in FIG. 22;

FIG. 24 is a partial perspective view illustrating a power supply substrate in FIG. 22;

FIGS. 25 and 26 are cross-sectional views illustrating the power supply module taken along the line VI-VI′ in FIG. 22;

FIG. 27 is a perspective view illustrating a power supply module in accordance with an embodiment of the present invention;

FIG. 28 is an exploded perspective view illustrating the power supply module in FIG. 27;

FIG. 29 is an exploded perspective view illustrating the power supply module in FIG. 28;

FIG. 30 is a cross-sectional view illustrating the power supply module taken along the line VII-VII′ in FIG. 28;

FIG. 31 is a cross-sectional view illustrating the power supply module taken along the line VIII-VIII′ in FIG. 28;

FIG. 32 is an exploded perspective view illustrating a power supply module in accordance with an embodiment of the present invention;

FIG. 33 is a perspective view illustrating a lamp holder in FIG. 32;

FIG. 34 is a cross-sectional view illustrating the power supply module taken along the line IX-IX′ in FIG. 32;

FIG. 35 is a perspective view illustrating a lamp holder in accordance with an embodiment of the present invention;

FIG. 36 is a perspective view illustrating a power supply module in accordance with an embodiment of the present invention;

FIG. 37 is an exploded perspective view illustrating the power supply module in FIG. 36;

FIG. 38 is a perspective view illustrating a power supply module in accordance with an embodiment of the present invention;

FIG. 39 is a cross-sectional view illustrating the power supply module taken along the line X-X′ in FIG. 38;

FIG. 40 is an exploded perspective view illustrating a power supply module in accordance with an embodiment of the present invention;

FIG. 41 is a cross-sectional view illustrating the power supply module taken along the line XI-XI′ in FIG. 40;

FIG. 42 is an exploded perspective view illustrating a backlight assembly in accordance with an embodiment of the present invention;

FIG. 43 is a cross-sectional view illustrating the backlight assembly taken along the line XII-XII′ in FIG. 42;

FIG. 44 is a cross-sectional view illustrating a backlight assembly in accordance with an embodiment of the present invention;

FIG. 45 is an exploded perspective view illustrating a backlight assembly in accordance with an embodiment of the present invention;

FIG. 46 is a cross-sectional view illustrating the backlight assembly taken along the line XIII-XIII′ in FIG. 45;

FIG. 47 is an exploded perspective view illustrating a backlight assembly in accordance with an embodiment of the present invention;

FIG. 48 is a cross-sectional view illustrating the backlight assembly taken along the line XIV-XIV′ in FIG. 47;

FIG. 49 is an exploded perspective view illustrating a display device in accordance with an embodiment of the present invention; and

FIG. 50 is a cross-sectional view illustrating the backlight assembly taken along the line XV-XV′ in FIG. 49.

### DESCRIPTION OF THE EMBODIMENTS

The present invention is described more fully hereinafter in reference to the accompanying drawings, in which example embodiments of the present invention are shown. The present invention may, however, be embodied in many different forms and should not be construed as limited to the exemplary embodiments set forth herein. These exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper,” “top,” “bottom” and the like, may be used herein for ease of description in reference to a figure, to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the present invention are described herein in reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Lamp

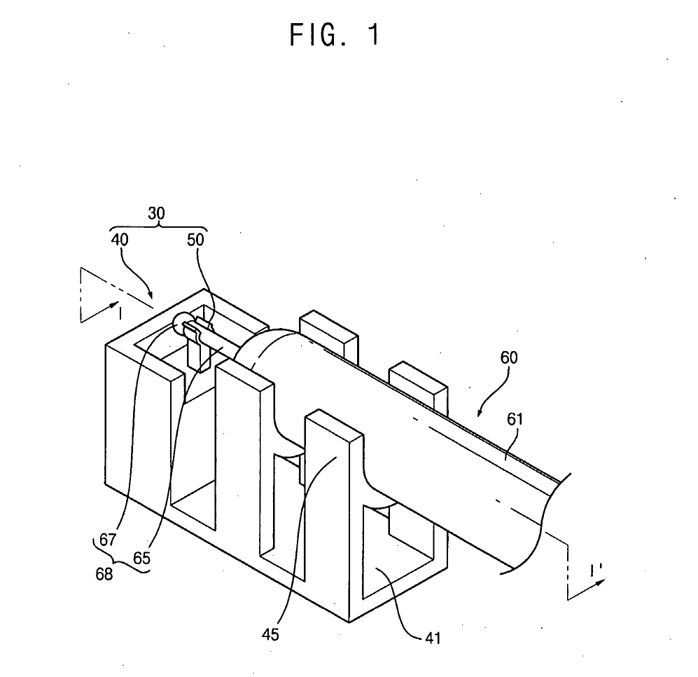

FIG. 1 is a perspective view illustrating a lamp and a lamp holder in accordance with an embodiment of the present invention.

Referring to FIG. 1, a lamp 60 is fixed to a lamp holder 30. Particularly, the lamp holder 30 holds the lamp 60 in the desired position. The lamp holder 30 is electrically connected to the lamp 60 so that a voltage is applied to the lamp 60 through the lamp holder 30. The lamp holder 30 includes a body 40 and a power supply member 50.

The body 40 of the lamp holder 30 includes a bottom portion 41 and a lamp support portion 45. The lamp support portion 45 extends from the bottom portion 41. The lamp support portion 45 has at least one lamp support groove on which an end portion of the lamp 60 rests.

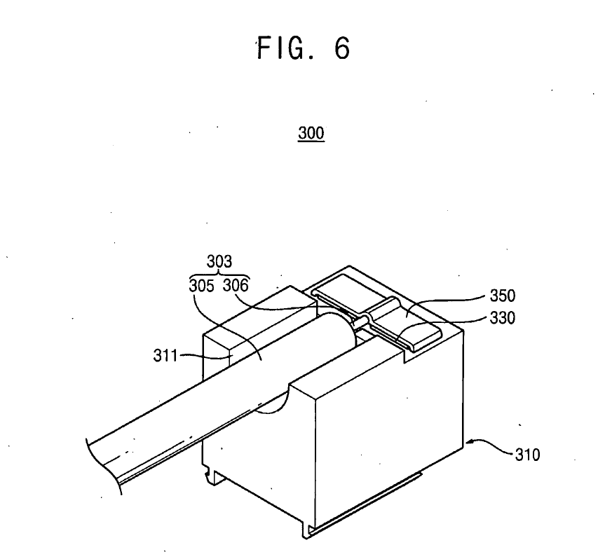

The power supply member 50 extends from the bottom portion 41 to an upper portion of the body 40. The power supply member 50 includes a first protruding portion that protrudes from the bottom portion 41. The first protruding portion of the power supply member 50 may be coupled to a connection terminal (which is described below in reference to FIG. 6). The power supply member 50 additionally includes a second protruding portion that extends from the upper portion of the body 40. The second protruding portion may be opposed to the first protruding portion. The second protruding portion of the power supply member 50 may be coupled to a power source through a structure shaped like a partially open ring.

The lamp 60 emits light in response to receiving a voltage through the lamp holder 30. In one embodiment, the lamp 60 is a cold cathode fluorescent lamp (CCFL). The lamp 60 includes a lamp tube 61, an electrode and a lamp lead 68.

The lamp tube 61 may include a transparent glass casing having a cylindrical shape. A fluorescent layer is formed on the inside of the lamp tube 61. The lamp tube 61 is filled with a discharging gas such as mercury (Hg) gas, a very small amount of argon (Ar) gas, neon (Ne) gas, xenon (Xe) gas, krypton (Kr) gas, etc. The lamp lead 68 may be disposed at an end portion of the lamp tube 61. The lamp-guide groove of the body 40 may guide the end portion of the lamp tube 61 so that the lamp lead 68 is coupled to the power supply member 50.

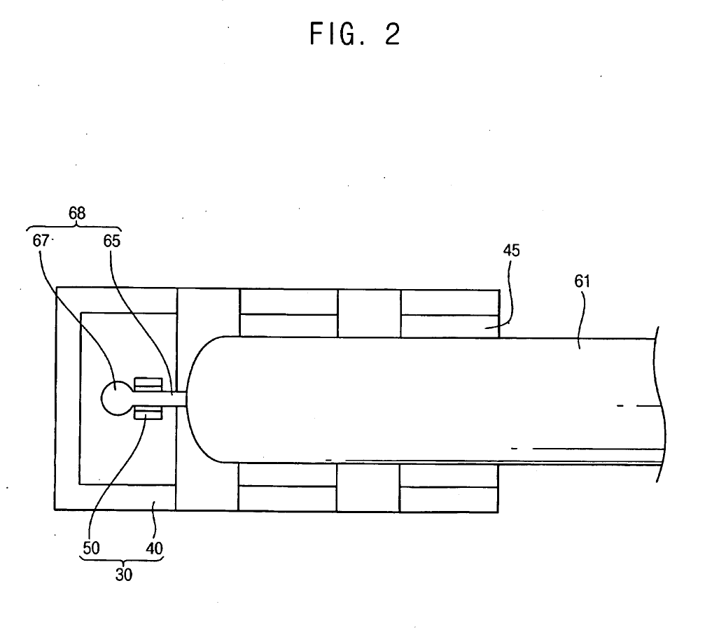

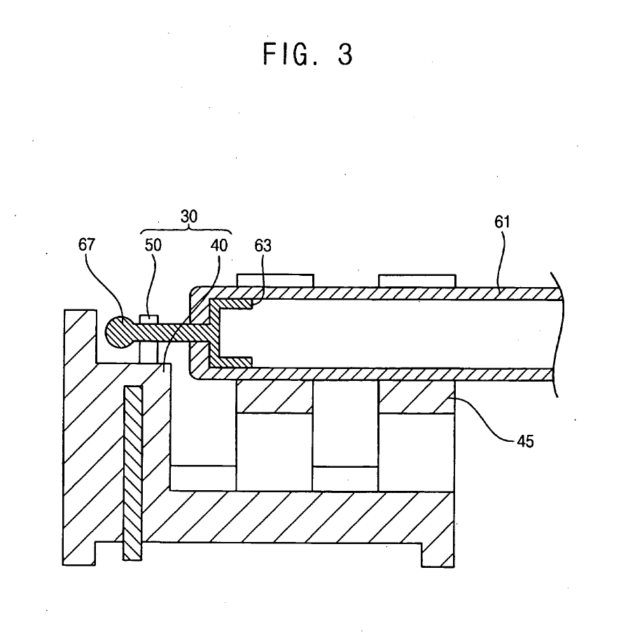

FIG. 2 is a plan view illustrating the lamp 60 and the lamp holder 30 in FIG. 1, and FIG. 3 is a cross-sectional view illustrating the lamp 60 taken along the line I-I′ in FIG. 1.

Referring to FIGS. 1 to 3, the lamp lead 68 electrically connects an electrode 63 of the lamp 60 to the power supply member 50. In an embodiment of the present invention, the lamp lead 68 includes a connecting portion 65 and a securing portion 67. The connecting portion 65 extends from the electrode 63 through the outer casing of the lamp tube 61 and is inserted into the power supply terminal of the power supply member 50. The securing portion 67 prevents the lamp lead 68 from sliding out of the power supply member 50. The securing portion 67 is positioned at an end of the connecting portion 65.

In an embodiment of the present invention, the securing portion 67 has a spherical shape. Here, the cross-section of the securing portion 67 may be substantially larger than the cross-section of the connecting portion 65 when both parts are “sliced” from top to bottom in reference to FIG. 3. The securing portion 67 having a diameter substantially larger than that of the connecting portion 65 ensures a secure connection between the lamp holder 30 and the lamp 60.

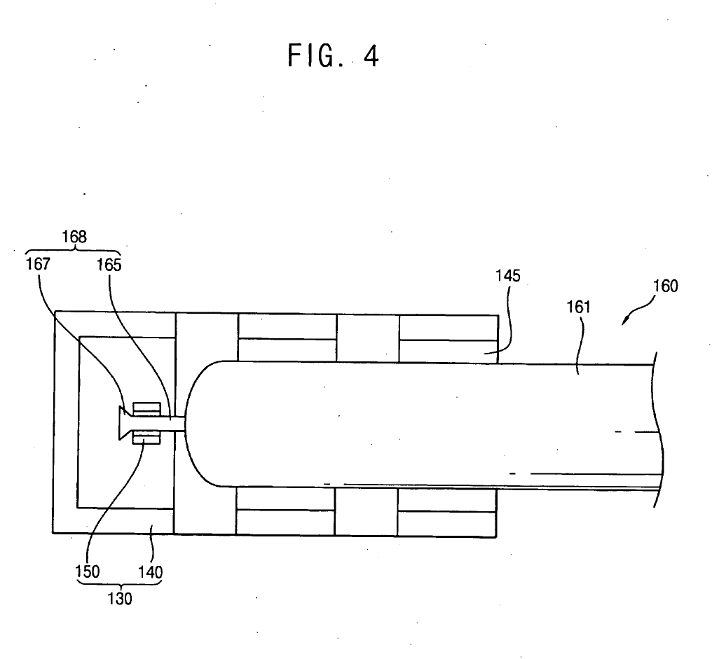

FIG. 4 is a plan view illustrating a lamp and a lamp holder in accordance with another embodiment of the present invention.

Referring to FIG. 4, a lamp 160 includes a lamp tube 161, an electrode (not shown but arranged similarly to the electrode 63 in FIG. 3) and a lamp lead 168. The lamp 160 may have a construction substantially the same as that of the lamp 60 described in reference to FIGS. 1 to 3, except for the structure of lamp lead 168.

The lamp holder 130 includes a body 140 and a power supply member 150. The body 140 of the lamp holder 130 has a lamp support portion 145 and a bottom portion. The lamp holder 130 has a construction that is substantially the same as that of the lamp holder 30 of FIGS. 1 to 3.

The lamp lead 168 of the lamp 160 includes a connecting portion 165 and a securing portion 167. The lamp lead 168 has a construction that is substantially the same as that of the lead 68 in FIGS. 1 to 3, except for the shape of the securing portion 167.

When the securing portion 167 and the connecting portion 165 are “sliced” into the page of FIG. 4, the cross-section of the securing portion 167 is substantially larger than the cross-section of the connecting portion 165. In this embodiment, the securing portion 167 may have a chamfer shape. That is, the cross-section of the securing portion 167 gradually increases with distance from the lamp tube 161. Therefore, the securing portion 167 of the lamp lead 168 securely connects the lamp 160 and the lamp holder 130 so that they do not separate even upon receiving an impact.

In the embodiments described above, the securing portions 67 and 167 have a spherical shape or a chamfer shape. However, these shapes are not limiting to the invention and the securing portion of the lead may have any of the known various shapes such as a hexagonal shape, a tetrahedral shape, etc. as long as the shape prevents the securing portion from sliding out of the power supply member 50.

Lamp Holder

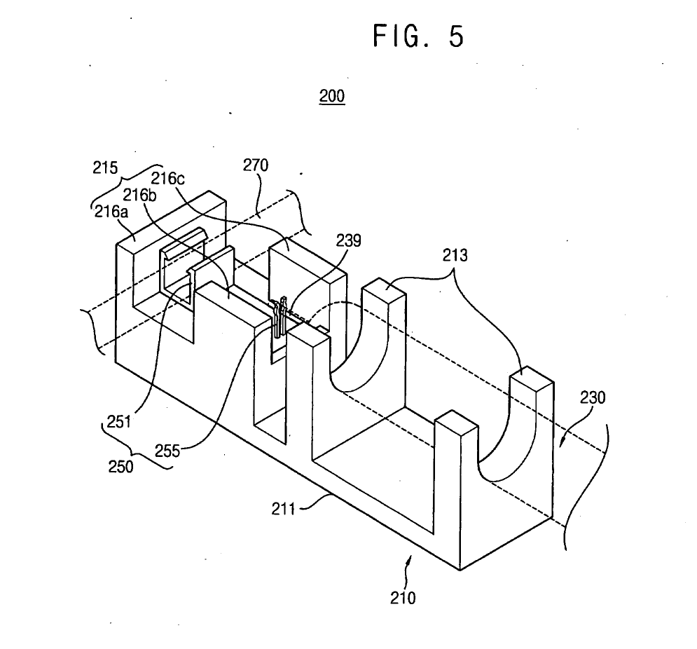

FIG. 5 is a perspective view illustrating a lamp holder 200 in accordance with an embodiment of the present invention.

Referring to FIG. 5, the lamp holder 200 electrically connects a lamp to a voltage supply wire so that a voltage is applied to the lamp. An outline of a lamp tube 230, and an outline of a voltage supply wire 270 are shown. The lamp may include a CCFL or an external electrode fluorescent lamp (EEFL). The lamp holder 200 includes a body 210 and a power supply member 250. The lamp tube is connected to a lamp lead 238, whose outline is also shown by broken lines.

The body 210 may include a material with good electrical insulating properties. The body 210 of the lamp holder 200 includes a bottom portion 211, a lamp support portion 213 and a wire guide portion 215.

The lamp support portion 213 protrudes from the bottom portion 211. A groove is formed at an upper portion of the lamp support portion 213 so that the lamp 230 can rest without rolling or sliding. An end portion of the lamp 230 is placed on the groove of the lamp support portion 213.

A wire guide portion 215 also protrudes from the bottom portion 211. The wire guide portion 215 may have the same height as the lamp support portion 213. As shown in FIG. 5, the wire guide portion 215 includes a first protruding portion 216a, a second protruding portion 216b and a third protruding portion 216c. The second and the third protruding portions 216b, 216c are disposed between the lamp support portion 213 and the first protruding portion 216a. The voltage supply wire (see voltage supply wire outline 270) is positioned between the first protruding portion 216a and the other protruding portions 216b, 216c.

The voltage supply wire 270 and the lamp lead 238 are inserted into the power supply member 250 so that the voltage supply wire 270 and the lamp lead 238 are fixed to the body 210 of the lamp holder 200. To securely fix the voltage supply wire 270 and the lamp lead 238 to the lamp holder 200, the power supply member 250 includes a first clip 251 and a second clip 255.

The first clip 251 is coupled to the voltage supply wire 270 by a pressure-welding connection method. The voltage supply wire may include a conductive wire, a coating layer, conductive beads, etc. The coating layer may enclose the conductive wire to electrically separate the conductive wire from the outside elements. The conductive beads may be buried in the coating layer. When the voltage supply wire (270) is held in the first clip 251, the conductive wire and the first clip 251 electrically connect to each other through the conductive beads buried in the coating layer. Here, the wire guide portion 215 supports the first clip 251 to prevent compromising the force with which the first clip 251 holds the voltage supply wire 270.

The second clip 255 holds the lamp lead 238. The second clip 255 extends from the first clip 251. The first and the second clips 251 and 255 may be integrally formed.

As described above, the voltage supply wire 270 and the lamp lead 238 are held by the power supply member 250 when the lamp 230 and the lamp holder 200 are assembled. This method of assembly securely couples the lamp holder 200 to the voltage supply wire 270 and efficiently combines the lamp 230 with the lamp holder 200.

FIG. 6 is a perspective view illustrating a lamp and a lamp holder in accordance with an embodiment of the present invention.

Referring to FIG. 6, a lamp holder 300 includes a body 310, a power supply member and a conductive adhesion member 350. A lamp 303 includes a lamp tube 305 and a lamp lead 306.

The body 310 of the lamp holder 300 has a lamp support groove 311 formed at an upper portion thereof. The body 310 may have a receiving space formed adjacent to the lamp support groove 311. The receiving space is not shown in FIG. 6 because it is covered by a conductive adhesion member 350. The power supply member (e.g., the power supply member 50 of FIG. 1) may be disposed in the receiving space of the body 310.

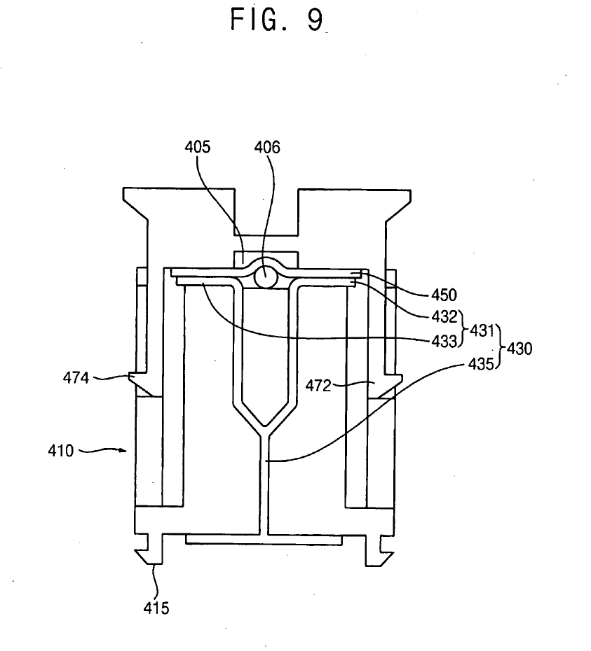

The power supply member includes a connection terminal and a power supply terminal (see, e.g., FIG. 9 below) that are connected to each other. The connection terminal extends toward the bottom of the body 310 and is exposed at the bottom surface of the body 310. The power supply terminal extends toward the top of the body 310 and is exposed in the receiving space of the body 310. In an embodiment of the present invention, the power supply terminal may be divided into two power supply terminal portions. The power supply terminal portions may be disposed parallel to each other at both sides of the lamp leads 306 when the lamp 303 is positioned on the lamp support groove 311.

The conductive adhesion member 350 may include an aluminum adhesive tape 330. The conductive adhesion member 350 covers the lamp lead 306 and the power supply terminal. The conductive adhesion member 350 electrically connects the lamp lead 306 to the power supply member.

Since the lamp holder 300 securely fixes the lamp 303 and the conductive adhesion member 350 effectively protects the lamp lead 306, damage to the lamp lead 306 is prevented.

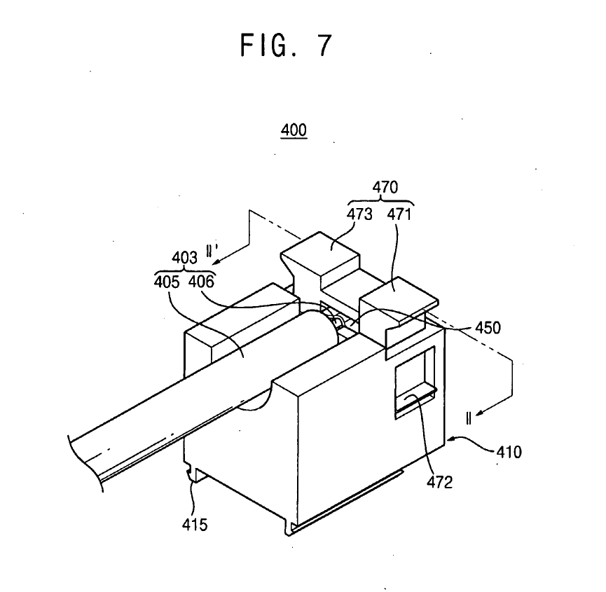

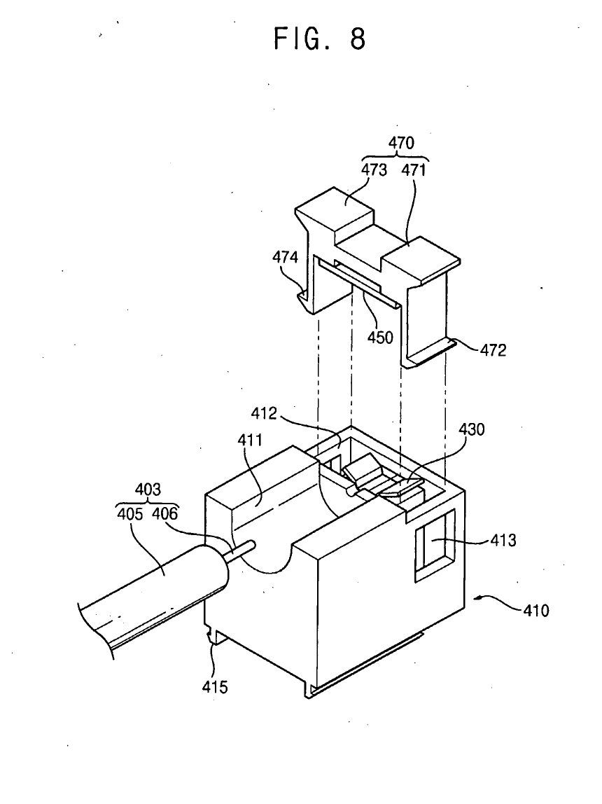

FIG. 7 is a perspective view illustrating a lamp and a lamp holder in accordance with an embodiment of the present invention, and FIG. 8 is an exploded perspective view illustrating the lamp and the lamp holder of FIG. 7.

Referring to FIGS. 7 and 8, a lamp holder 400 includes a body 410, a power supply member 430 and a conductive adhesion member 450. The lamp holder 400 may be advantageously employed in a direct-type backlight assembly that provides light in a display device. A lamp 403 includes a lamp tube 405 and a lamp lead 406.

The body 410 of the lamp holder 400 may be formed through an injection molding method. The body 410 may have a substantially hexahedral shape but not every facet of the hexahedron is a flat surface. The body 410 has a top face, a bottom face, and lateral portions connecting the bottom face to the upper face.

A lamp support groove 411 is formed at an upper portion of the body 410. More specifically, the lamp guide 411 is part of the upper surface of the body 410. The lamp support groove 411 may have a semi-spherical shape to stably receive the lamp 403. A receiving space 412 having a predetermined depth is formed at the upper face of the body 410 next to the lamp support groove 411, to receive the power supply member 430. Connection holes 413 are formed at the lateral portions of the body 410. The connection holes 413 communicate with the receiving space 412. Connection protrusions 415 are formed at the bottom surface of the body 410.

FIG. 9 is a cross-sectional view illustrating a cross section of the lamp 403 and the lamp holder 400 taken along the line II-II′ in FIG. 7.

Referring to FIGS. 7, 8, and 9, the power supply member 430 may be formed using an electrically conductive metal. The power supply member 430 is disposed in the receiving space 412 and fixed to the body 410 of the lamp holder 400. The power supply member 430 includes a power supply terminal 431 and a connection terminal 435. The power supply terminal 431 includes two divided power supply terminal portions 432 and 433 formed at both sides of the lamp lead 406 disposed in the lamp support groove 411. A portion of the connection terminal 435 is shaped like a “T” with the top of the “T” parallel to the bottom surface of the body 410. As shown, the top of the “T” is exposed on the bottom surface of the body 410.

The conductive adhesion member 450 electrically connects the lead 406 to the power supply terminal portions 432, 433. The conductive adhesion member 450 covers the lamp lead 406 and the power supply terminal portions 432, 433. The conductive adhesion member 450 may be formed using a material that has good electrical conductivity and flexibility, such as an aluminum tape.

The lamp holder 400 further includes a holder cap 470. The holder cap 470 has a first fixing portion 471 and a second fixing portion 473. There is a gap separating the lower portions of the first and the second fixing portions 471. Connection hooks 472 and 474 are formed at the lower portions of the first and the second fixing portions 471 and 473, respectively. The connection hooks 472 and 474 are structurally similar to each other.

When the first and the second fixing portions 471 and 473 are inserted into the receiving space 412, the connection hooks 472 and 474 are respectively inserted into the connection holes 413 on the sides of the body 410. The holder cap 470 is inserted into the receiving space 412 while coupling the connection hooks 472 and 474 to the connection holes 413. The holder cap 470 is able to slide up and down in the receiving space 412.

In accordance with a combination of the holder cap 470 and the receiving space 412, the holder cap 470 presses down on the conductive adhesion member 450 so that the conductive adhesion member 450 makes contact with the lead 406 and the power supply terminal portions 432 and 433. Thus, as shown in FIG. 9, the lamp lead 406 is electrically connected to the power supply terminal portions 432 and 433 through the conductive adhesion member 450.

With the invention, a secure electrical connection between the lamp lead 406 and the power supply terminal portions 432 and 433 is maintained and the lamp lead 406 and the lamp tube 405 are protected even if the lamp lead 406 were moved due to an external impact as long as the lamp lead 406 is attached to the conductive adhesion member 450.

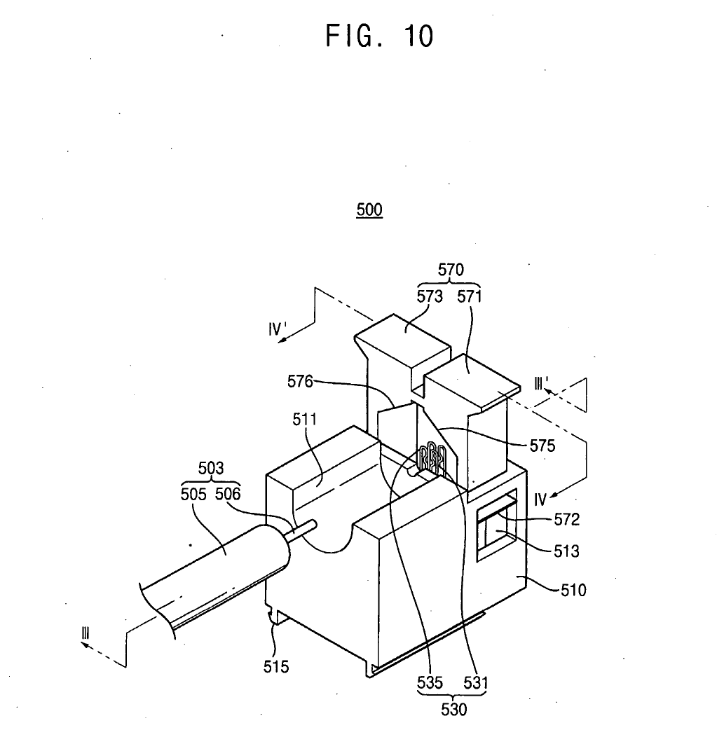

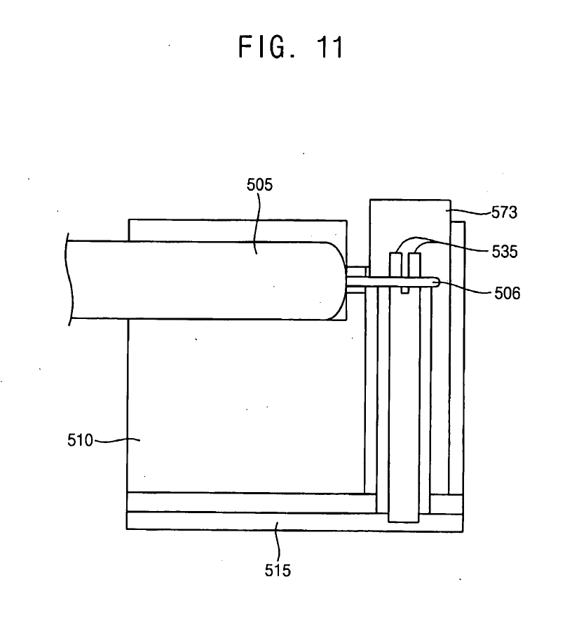

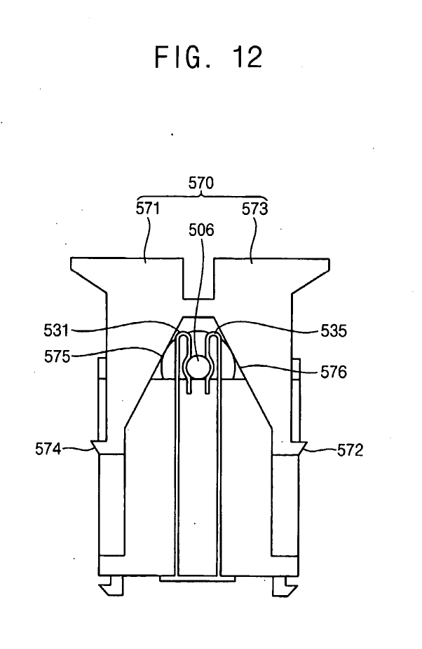

FIGS. 10, 11, and 12 show another embodiment of the present invention. FIG. 10 is an exploded perspective view illustrating a lamp and a lamp holder. FIG. 11 is a cross-sectional view illustrating the lamp and the lamp holder taken along the line III-III′ in FIG. 10, and FIG. 12 is a cross-sectional view illustrating the lamp and the lamp holder taken along the line IV-IV′ in FIG. 10.

Referring to FIG. 10, a lamp holder 500 includes a body 510, a power supply member 530 and a holder cap 570. A lamp 503 includes a lamp tube 505 and a lamp lead 506.

The body 510 of the lamp holder 500 has a hexahedral shape. The body 510 includes a top face, a bottom face, and lateral portions connecting the top face to the bottom face.

A rounded lamp support groove 511 is formed at the top face of the body 510 of the lamp holder 500. A receiving space having a predetermined depth may be formed at the top face of the body 510 next to the lamp support groove 511. The lateral portions of the body 510 extend along the lamp support groove 511 and the receiving space. Connection holes 513 communicating with the receiving space are formed at the lateral portions of the body 510.

Referring to FIGS. 11 and 12, the power supply member 530 is disposed in the receiving space. The power supply member 530 includes a first connection terminal 531 and a second connection terminal 535 that are fixed to a bottom surface of the receiving space.

Lower portions of the first and the second connection terminals 531 and 535 are fixed to the bottom face of the receiving space, as shown in FIG. 12. Upper portions of the first and the second connection terminals 531 and 535 extend from the top face of the body 510. Each of the upper portions of the first and the second connection terminals 531 and 535 is divided into two connection terminal portions. The upper portions of the first and the second connection terminals 531 and 535 bend toward the bottom face of the body 510, and then are contacted with lateral portions of the lamp lead 506.

The holder cap 570 includes a first fixing portion 571 and a second fixing portion 573. The first and the second fixing portions 571 and 573 are inserted into the receiving space. Particularly, lower portions of the first and the second fixing portions 571 and 573 are inserted into the receiving space such that upper portions of the first and the second fixing portions 571 and 573 protrude from the receiving space. The upper portions of the first and the second fixing portions 571 and 573 are connected to each other while the lower portions of the first and the second fixing portions 571 and 573 are separated from each other by a first interval.

The holder cap 570 includes a first inclined face 575 and a second inclined face 576. The first and the second inclined faces 575 and 576 are disposed between the upper portions and the lower portions of the fixing portions 571 and 573. A distance between the first inclined face 575 and the second inclined face 576 increases as the first and second inclined faces 575, 576 extend closer to the bottom surface of the body 510.

A first connection hook 572 and a second connection hook 574 are provided at the lower portion of the first fixing portion 571 and the lower portion of the second fixing portion 573, respectively. The first and the second connection hooks 572 and 574 are inserted into the connection hole. 513 to couple the holder cap 570 to the body 510. When the first and the second connection hooks 572 and 574 are inserted into the connection hole 513, the first and the second inclined faces 575 and 576 are contacted with the upper portions of the first and the second connection terminals 531 and 535, respectively. As the holder cap 570 is placed in the receiving space, the inclined faces 575, 576 press the upper portions of the first and the second connection terminals 531 and 535 closer together. Hence, the first and the second connection terminals 531 and 535 make contact with the lamp lead 506 of the lamp 503.

As described above, each of the upper portions of first and the second connection terminals 531 and 535 is divided into two connection terminal portions. A secure electrical connection between the lamp lead 506 and the first and the second connection terminals 531 and 535 is maintained because the holder cap 570 holds the first and the second connection terminals 531 and 535 in contact with the lamp lead 506.

In another embodiment of the present invention, each of the first and the second connection terminals 531 and 535 includes more than three connection terminal portions.

When assembled with the lamp holders described in reference to FIGS. 6 to 12, the lead of the lamp may slightly move because of the conductive adhesion member of the lamp holder or the first and the second connection terminals having two divided connection terminal portions. The divided connection terminal portions maintain electrical connections with the lamp lead. The connection terminal portions also protect the lamp tube and the lamp lead to prevent damage when an external impact is received.

Power Supply Module

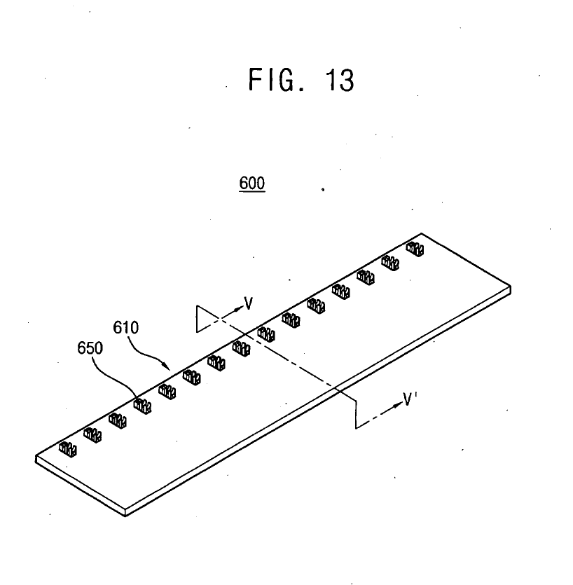

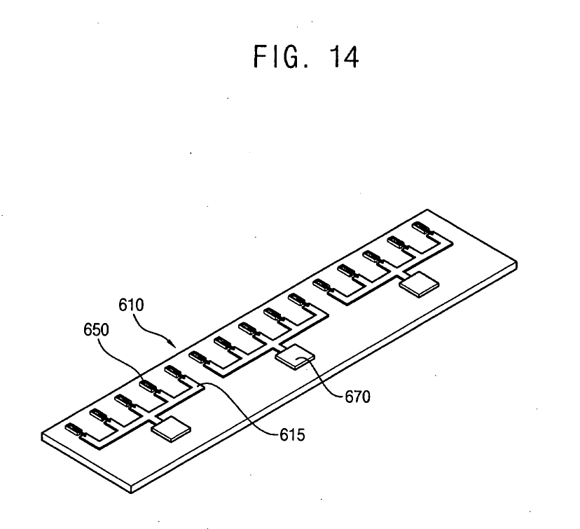

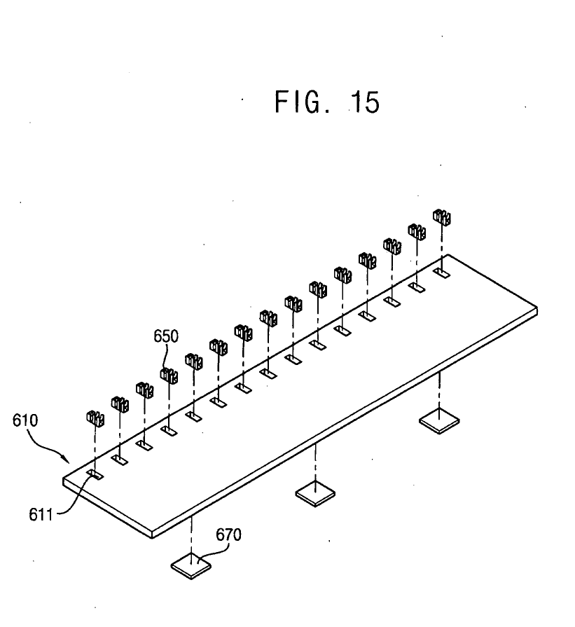

FIG. 13 is a top perspective view illustrating a power supply module in accordance with an embodiment of the present invention, FIG. 14 is a bottom perspective view illustrating the power supply module in FIG. 13 (FIG. 14 is upside down relative to FIG. 13), and FIG. 15 is an exploded view illustrating the power supply module in FIG. 13.

Referring to FIGS. 13 to 15, a power supply module 600 includes a power supply substrate 610 and lamp holders 650.

The power supply substrate 610 is a plate having a top surface and a bottom surface. As shown in FIG. 14, connection portions 615 are formed on the bottom surface of the power supply substrate 610. Voltages may be applied to the lamp holders 650 through the connection portions 615. The connection portions 615 may include a conductive wiring that is partially exposed on the power supply substrate 610.

The power supply substrate 610 further includes fixing portions for attaching the lamp holders 650 to the power supply substrate 610. In an embodiment of the present invention, the fixing portions include fixing holes 611 that are formed along the length of the power supply substrate 610.

The power supply module 600 further includes power supply devices 670. The power supply devices 670 are disposed on the bottom surface of the power supply substrate 610. The voltages may be emitted from the power supply devices 670. The power supply devices 670 may include inverters that emit second voltages by converting first voltages provided from the outside into the second voltages. The inverters may convert alternating current (AC) power provided from the outside into direct current (DC) power. The inverters may raise or reduce the converted DC power to predetermined levels for the lamps. Additionally, the raised or reduced DC power may be converted into AC power by the inverters.

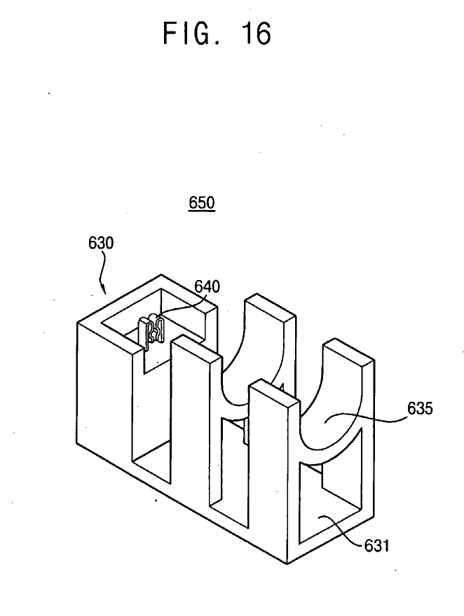

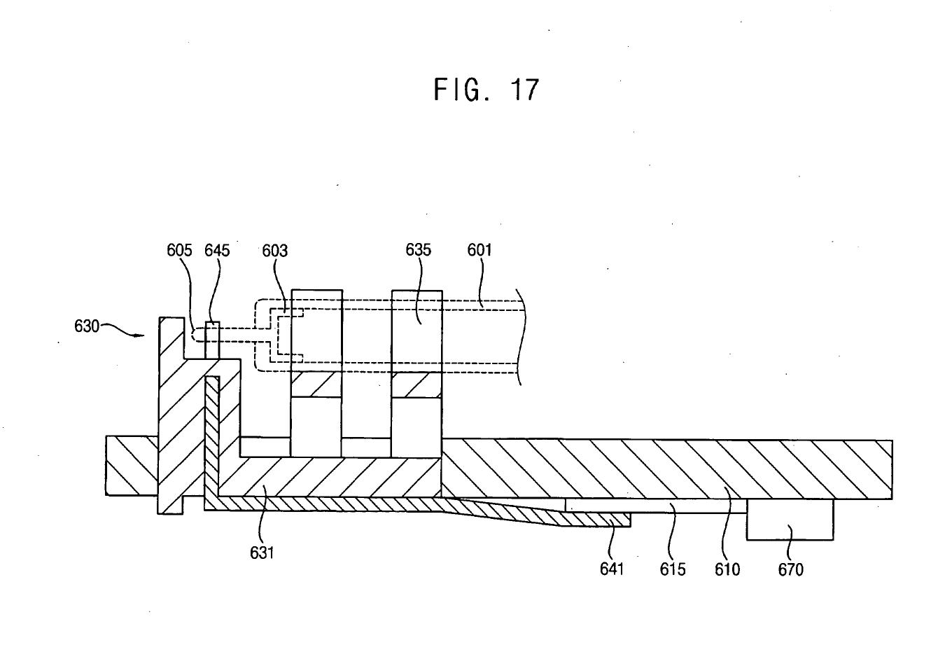

FIG. 16 is a perspective view illustrating a lamp holder in accordance with an embodiment of the present invention and FIG. 17 is a cross-sectional view illustrating the power supply module taken along the line V-V′ in FIG. 13.

Referring to FIGS. 16 and 17, the lamp holders 650 fix lamps 601 to the power supply substrate 610, and apply the voltages to the lamps 601. Each of the lamp holders 650 includes a body 630 and a power supply member 640.

The body 630 of the lamp holder 650 is detachably inserted into one of the fixing holes 611 (see FIG. 15). The bodies 630 are inserted into the fixing holes 611 from the top surface of the power supply substrate 610 from a first end to a second end. Alternatively, the body 630 is inserted into one of the fixing holes 611 from a second end to the first end.

Each body 630 may be formed using a material with good electrical insulating properties. The body 630 includes a bottom portion 631 and a lamp support portion 635. The lamp support portion 635 extends from the bottom portion 631. Grooves formed at upper portions of the lamp support portion 635 to hold an end portion of the lamp 601 and prevent the lamp 601 from rolling or laterally sliding.

The power supply members 640 electrically connect a lamp lead 605 of the lamp 601 to the connection portion 615 on the bottom surface of the power supply substrate 610. The power supply member 640 extends through the body 630 of the lamp holder 650. The power supply member 640 includes a connection terminal 641 and a power supply terminal 645.

The connection terminal 641 is exposed at a lower portion of the body 630 and extend along the bottom surface of the power supply substrate 610. The connection terminal 641 makes contact with the connection portion 615. Alternatively, the connection terminal 641 may be attached to the connection portion 615 by a soldering method.

The power supply terminal 645 extends from the connection terminal 641, and extend above an upper surface of the body 610 of the lamp holder 650. The structure of the power supply terminal 645 is substantially the same as that of the upper portion of the first and second connection terminals 531 and 535 shown in FIGS. 10 to 12. The lamp lead 605 is inserted into the power supply terminal 645.

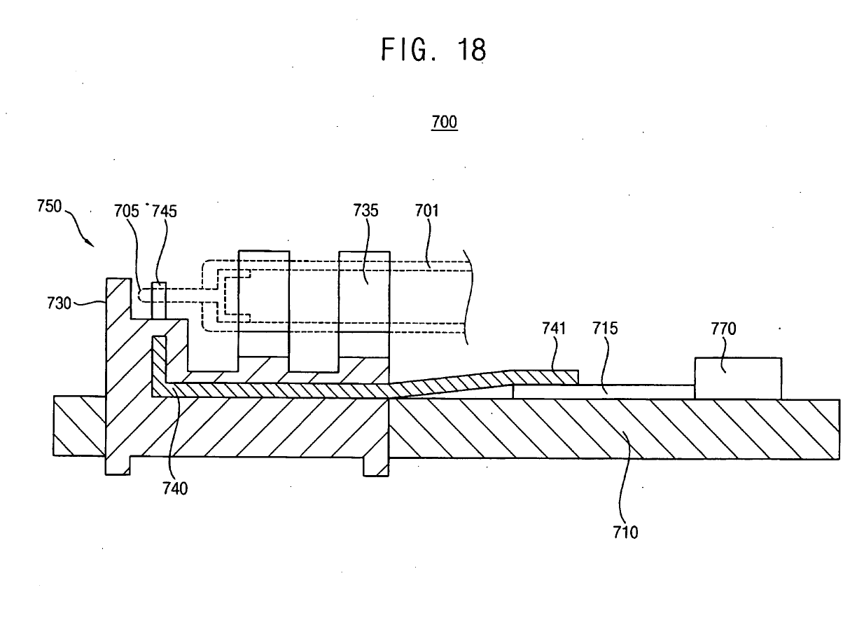

FIG. 18 is a cross-sectional view illustrating a power supply module in accordance with another embodiment of the power supply module.

Referring to FIG. 18, a power supply module 700 includes a power supply substrate 710, a lamp holder 750 and a power supply device 770. The power supply substrate 710 has a top surface and a bottom surface.

The power supply module 700 has a construction that is substantially the same as that of the power supply module 600 described in reference to FIGS. 13 to 17, except that the power supply device 770 is disposed on the top surface of the power supply substrate 710, a connection pad 715 is formed on the top surface of the power supply substrate 710, and a connection terminal 741 protrudes from lateral portions of the body 730 of the lamp holders 750 to contact the connection portion 715.

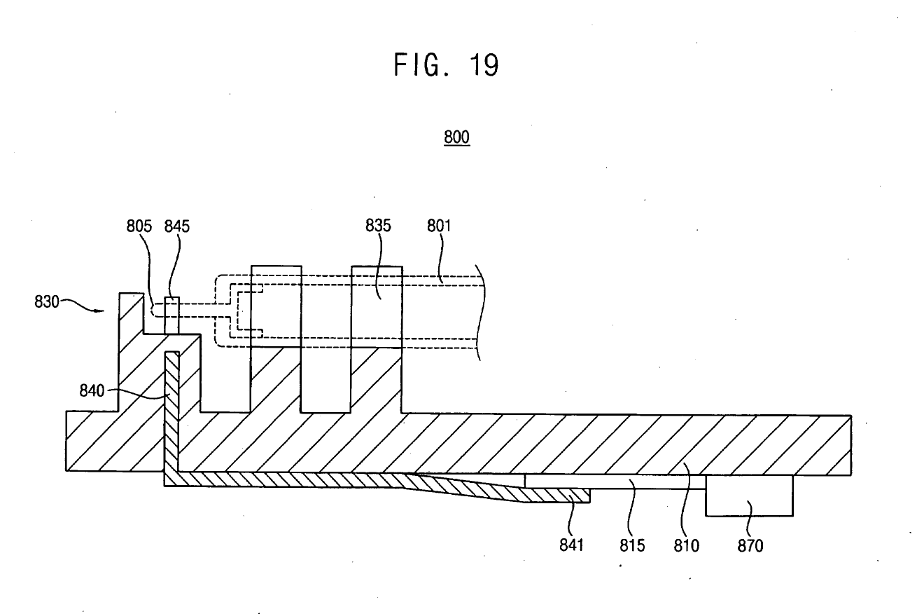

FIG. 19 is a cross-sectional view illustrating a power supply module in accordance with yet another embodiment of the present invention.

Referring to FIG. 19, a power supply module 800 includes a power supply substrate 810, a power supply member 840 and a power supply device 870. The power supply module 800 has a construction that is substantially the same as that of the power supply module 600 described in reference to FIGS. 13 to 17, except for the power supply substrate 810 having an integrated lamp holding portion 830 instead of the lamp holder 650.

The power supply substrate 810 is a plate having a top surface and a bottom surface. The power supply device 870 is installed on the bottom surface of the power supply substrate 810. Additionally, a connection portion 815 is formed on the bottom surface of the power supply substrate 810. The connection portion 815 is electrically connected to the power supply device 870.

The lamp holding portion 830 protrudes from peripheral portions of the top surface of the power supply substrate 810 along the length of the power supply substrate 810. The lamp holding portion 830 is integrally formed with the power supply substrate 810. The lamp holding portion 830 has a lamp support groove 835 designed to hold an end portion of a lamp 801.

The power supply member 840 has a structure that is substantially the same as that of the power supply member described in reference to FIGS. 13 to 17. The power supply member 840 extends through the lamp holding portions 830. The power supply member 840 includes a connection terminal 841 and a power supply terminal 845. The connection terminal 841 extends along the bottom surface of the power supply substrate 810 to contact the connection portion 815.

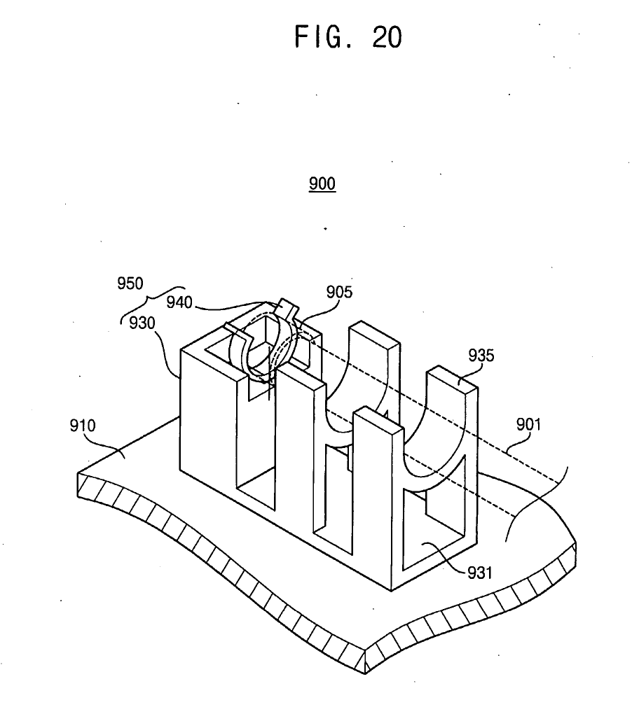

FIG. 20 is a partially cut perspective view illustrating a power supply module in accordance with yet another embodiment of the present invention.

Referring to FIG. 20, a power supply module 900 includes a power supply substrate 910, a lamp holder 950 and a power supply device. The power supply module 900 may have a construction substantially the same as that of the power supply module 600 described in reference to FIGS. 13 to 17, except for the lamp holder 950.

The lamp holder 950 includes a body 930 and a power supply member 940. The body 930 has a structure that is substantially the same as that of the body 630 described in reference to FIG. 16.

The power supply member 940 includes a connection terminal and a power supply terminal. The connection terminal is exposed at the bottom of the body 930, similarly to the power supply member 640 shown in FIG. 17. The connection terminal makes contact with a connection portion formed on a bottom surface of the power supply substrate 910. The power supply terminal extends from the connection terminal to be exposed at a top surface of the body 930. The power supply terminal may have a partially open ring shape.

Each power supply terminal fixes an electrode 905 of an EEFL 901 in place and applies a voltage to the electrode 905.

In an embodiment of the present invention, a power supply module includes a lamp holder unit that has a plurality of lamp holders arranged on a power supply substrate and spaced apart at a regular interval.

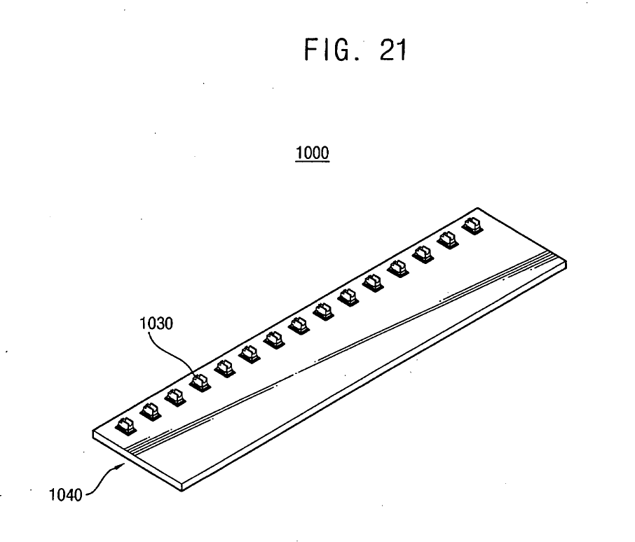

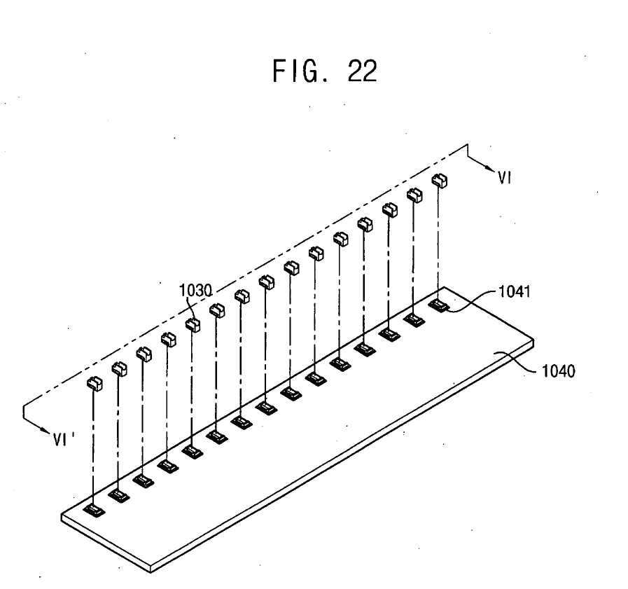

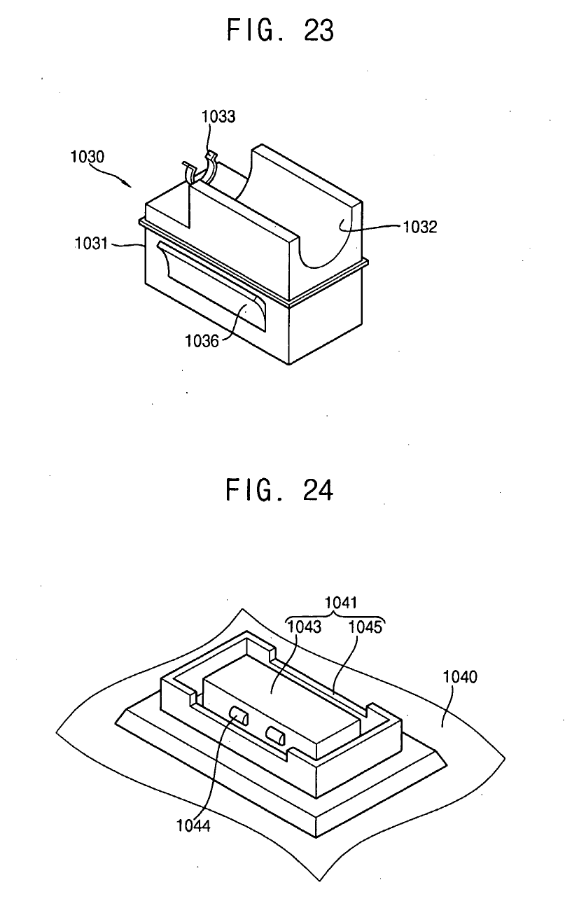

FIG. 21 is a perspective view illustrating a power supply module in accordance with an embodiment of the present invention, FIG. 22 is an exploded perspective view illustrating the power supply module of FIG. 21, and FIG. 23 is a perspective view illustrating a lamp holder of FIG. 22.

Referring to FIGS. 21 to 23, a power supply module 1000 includes lamp holders 1030 and a power supply substrate 1040.

The lamp holders 1030 are electrically connected to the power supply substrate 1040 so that voltages are applied to lamps through the lamp holders 1030. The lamp holders 1030 fix the lamps to the power supply substrate 1040. Each of the lamp holders 1030 includes a body 1031 and a power supply member 1033.

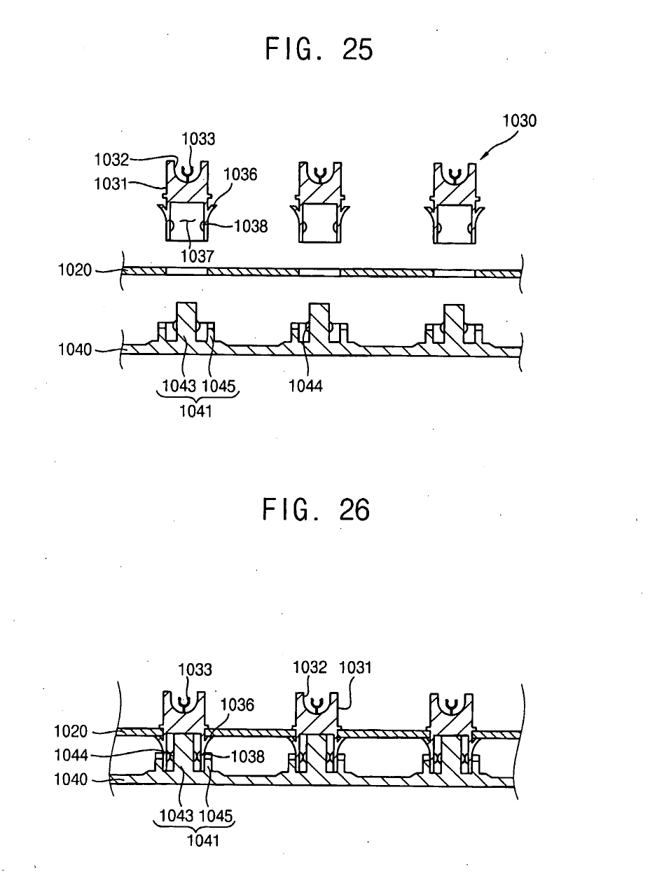

The body 1031 has a lamp support groove 1032 at its upper portion and a coupling groove at its lower portion (see coupling groove 1037 in FIG. 25). The body 1031 may be formed using a material with good electrical insulating properties. A fixing hook 1036 is disposed on a lateral portion of the body 1031.

The power supply member 1033 applies voltages to the lamp disposed in the lamp support groove 1032. The power supply member 1033 extends from the lower portion of the body 1031 to the upper portion of the body 1031. The power supply member 1033 includes a connection terminal and a power supply terminal.

The connection terminal protrudes toward the coupling grooves formed at the lower portion of the body 1031. The power supply terminal extends from the connection terminal and protrudes from the upper portion of the bodies 1031. The power supply terminal may have a partially open ring shape that allows it to receive a lamp lead.

FIG. 24 is a partial perspective view illustrating the power supply substrate of FIG. 22.

Referring to FIG. 24, the power supply substrate 1040 provides voltages to the power supply member 1033. The power supply substrate 1040 includes an insulation substrate, a power supply device, and a conductive wiring.

The insulation substrate has a top surface and a bottom surface. The power supply devices are installed on the bottom surface of the insulation substrate. The power supply devices may include inverters that emit the voltages for driving the lamps based on source voltages provided from the outside into the voltages. The inverters may convert AC power provided from the outside into DC power. The inverters may raise or reduce the converted DC power to a predetermined level for the lamps. Additionally, the raised or reduced DC power may be converted into AC power by the inverters.

In an embodiment of the present invention, the power supply substrate 1040 may include a balance board for uniformly applying a plurality of lamps with voltages provided from the inverters.

The conductive wiring is electrically connected to the power supply devices. The conductive wiring is partially exposed at the front surface of the insulation substrate to form a connection portion 1044 designed to connect with the connection terminal of the power supply member 1003.

FIGS. 25 and 26 are cross-sectional views illustrating the power supply module taken along the line VI-VI′ of FIG. 22. Particularly, FIG. 25 illustrates the lamp holders 1030 separated from the power supply substrate 1040 whereas FIG. 26 illustrates the lamp holders 1030 combined with the power supply substrate 1040.

Referring to FIGS. 24 and 26, a fixing portion 1041 is formed on the front surface of the insulation substrate. The lamp holder 1030 is fixed to the fixing portion 1041. The fixing portion 1041 may be integrally formed with the insulation substrate. Alternatively, the fixing portion 1041 and the insulation substrate may be separate parts that can be assembled. In this case, the fixing portion 1041 may be combined with the insulation substrate by various methods.

The body 1031 of the lamp holder 1030 is detachably coupled to the fixing portion 1041. The fixing portion 1041 includes a first protruding portion 1043 and a second protruding portion 1045.

The first protruding portion 1043 has a first height measured from the front surface of the insulation substrate. The second protruding portion 1045 has a second height substantially lower than the first height. The second protruding portion 1045 protrudes from a portion of the front surface of the insulation substrate that is adjacent to the first protruding portion 1043. The first protruding portion 1043 is inserted into the coupling grooves 1037 of the bodies 1031. The second protruding portions 1045 partially cover outer sides of the lower portions of the bodies 1031.

The connection portion 1044 is exposed on a lateral portion of the first protruding portion 1043. When the first protruding portion 1043 is inserted into the coupling groove 1037, the connection terminal 1038 that protrudes inward in the coupling groove 1037 contact the connection portion 1044. As electricity flows between the connection terminal 1038 and the connection portion 1044, the voltages provided from the power supply devices are applied to the lamps.

Referring to FIGS. 25 and 26, the power supply substrate 1040 is combined with the lamp holders 1030 that are fixed on a connection member 1020. The connection member 1020, for example, may include a bottom plate of a receiving container on which the lamps holders 1030 are disposed. The connection member 1020 may have a uniaxially extended plate structure. The connection member 1020 has a plurality of openings where the lamp holders 1030 are inserted. The openings may be serially arranged along the length of the connection member 1020. The connection member 1020 and the power supply substrate 1040 may be coupled to each other with a screw.

The fixing hook 1036 formed on the body 1031 is coupled to a bottom surface of the connection member 1020 as shown in FIG. 26. The fixing hook 1036 prevents the body 1031 of the lamp holder 1030 from sliding out through the opening of the connection member 1020.

According to the power supply modules 600, 700, 800, 900 and 1000 described in reference to FIGS. 13 to 26, the lamp lead is detachably combined with the power supply member of the lamp holder, and the connection terminal of the lamp holder directly contacts the connection portion on the power supply substrate. Therefore, electrical connection between the connection terminal and the connection portion or between the lamp lead and the connection terminal is securely established. The components of the power supply module lend themselves to efficient assembly.

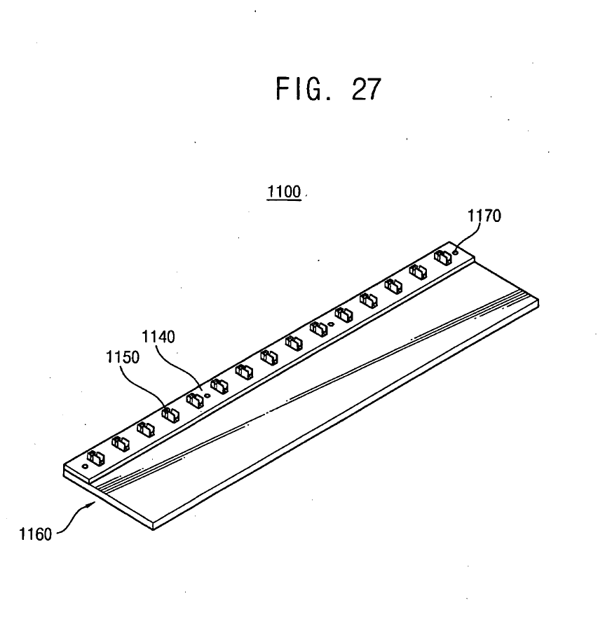

FIGS. 27-31 illustrate embodiments of the invention where the power supply module includes a connection plate.

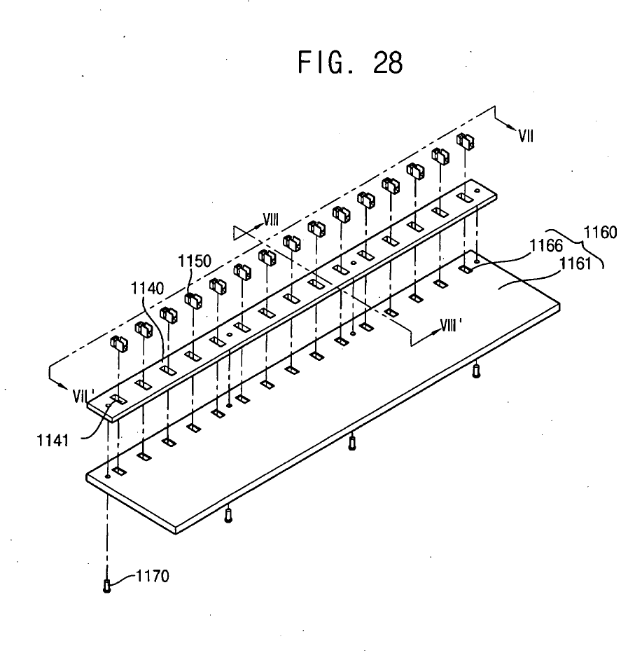

FIG. 27 is a perspective view illustrating a power supply module in accordance with an embodiment of the present invention, and FIG. 28 is an exploded perspective view illustrating the power supply module of FIG. 27.

Referring to. FIGS. 27 and 28, a power supply module 1100 includes a plurality of lamp holders 1150 and a power supply substrate 1160.

Each of the lamp holders 1150 includes a body and a power supply member, as described above. The body of the lamp holder 1150 has a structure that is substantially the same as that of the body 630 described in reference to FIGS. 16 and 17.

The power supply member extends through the body. As described above, the power supply member extends from the upper portion of the body to the lower portion. The power supply member includes a connection terminal and a power supply terminal, and the connection terminal is exposed at the lower portion of the body. The power supply terminal extends from the connection terminal and is exposed at the upper portion of the body.

The connection terminal receives voltages from the power supply substrate 1160. The connection terminal has a structure that is substantially the same as that of the connection terminal described in reference to FIG. 23.

In an embodiment of the present invention, the power supply module 1100 further includes a connection plate 1140 for easy assembly of the lamp holders 1150 with the power supply substrate 1160.

The connection plate 1140 may have a uniaxially extended plate shape and is formed using an insulation material. The connection plate 1140 includes a plurality of fixing holes 1141 into which the bodies of the lamp holders 1150 are inserted. The fixing holes 1141 are disposed along the length of the connection plate 1140. The connection plate 1140 further includes screw portions for combining the power supply substrate 1160 with the connection plate 1140.

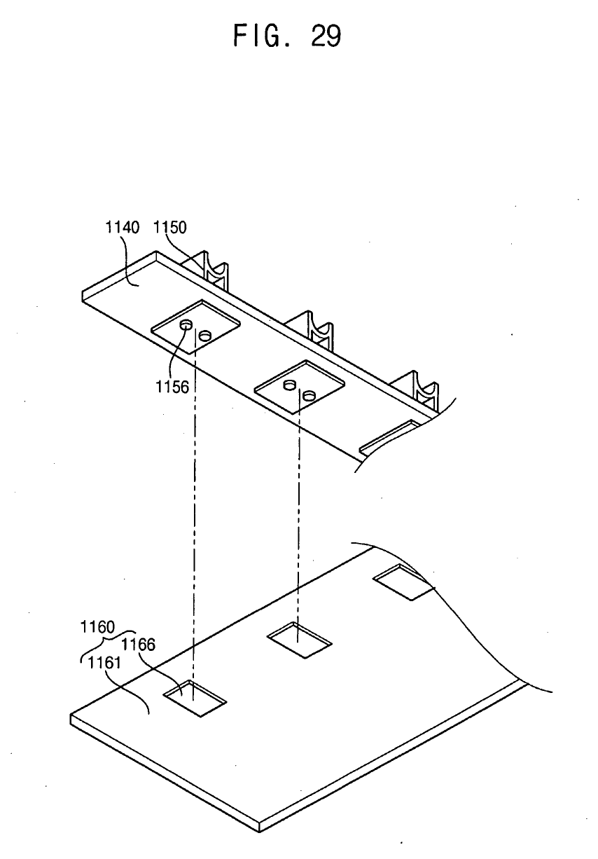

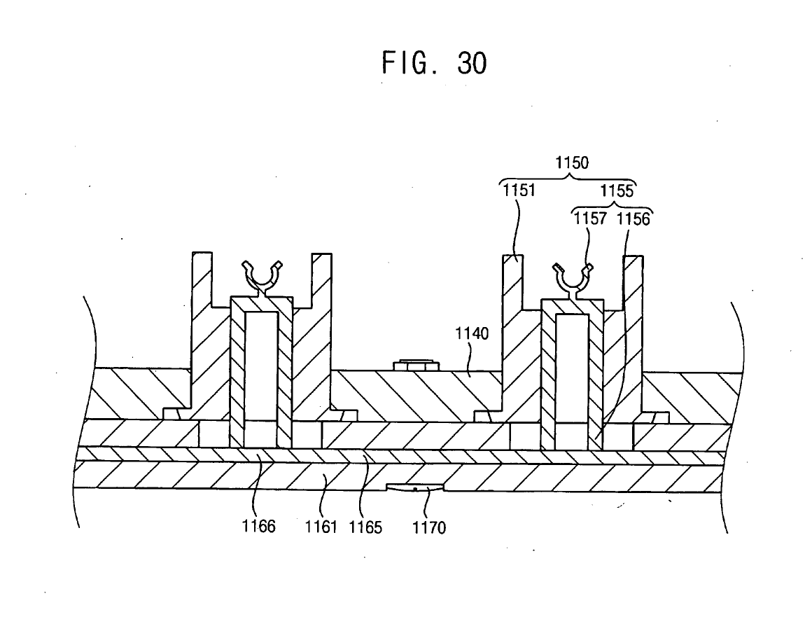

FIG. 29 is an exploded perspective view illustrating the power supply module of FIG. 28, and FIG. 30 is a cross-sectional view illustrating the power supply module taken along the line VII-VII′ of FIG. 28.

Referring to FIGS. 28 to 30, the power supply substrate 1160 is coupled to the connection plate 1140. The power supply substrate 1160 includes connection portions 1166 that make contact with the power supply members 1155. In particular, the power supply substrate 1160 includes an insulation substrate 1161, power supply devices and a conductive wiring 1165.

The insulation substrate 1161 is combined with the connection plate 1140. The insulation substrate 1161 is substantially wider than the connection plate 1140. The insulation substrate 1161 may have a length substantially similar to that of the connection plate 1140. The insulation substrate 1161 has a top surface on which the connection plate 1140 is disposed, and a bottom surface. The insulation substrate 1161 includes female screw portions extending from the bottom surface to the front surface of the insulation substrate 1161. The female screw portions of the insulation substrate 1161 is aligned with the screw portions of the connection plate 1140 to allow the screw to extend through both components.

The power supply devices are disposed on the bottom surface of the insulation substrate 1161 to thereby provide voltages. The number of the power supply devices may vary in accordance with the number of the lamp holders 1150. For example, one power supply device may provide all of the lamp holders with the voltages. Alternatively, the lamp holders may be divided into groups and one or more power supply devices may provide power to each groups of lamp holders.

The conductive wiring 1165 is disposed in the insulation substrate 1161 and electrically insulated from the outside. The upper portion of the insulation substrate 1161 is partially removed in accordance with formations of the fixing holes 1141 on the connection plate 1140. Portions of the conductive wiring 1165 are exposed from the front face of the insulation substrate 1161, thereby forming the connection portions 1166 on the front face of the insulation substrate 1161.

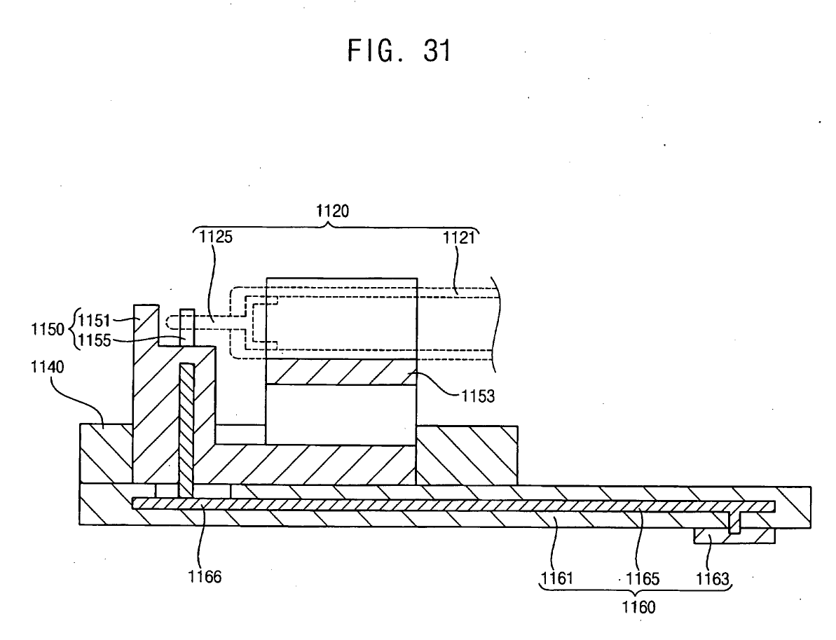

FIG. 31 is a cross-sectional view illustrating the power supply module taken along the line VIII-VIII′ in FIG. 28.

Referring to FIGS. 30 and 31, the lamp holders 1150 fix end portions of the lamps 1120 to the power supply module 1100. When the lamps include CCFLs shown in FIG. 31, the electrodes 1125 of the lamps 1120 include discharging electrodes and lamp leads.

The discharging electrodes are disposed in lamp tubes 1121 of the lamps 1120 whereas the leads protrude from the lamp tubes 1121. Each of the leads are held by a power supply terminal 1157 protruding from the body 1151 of the lamp holders 1150.

In an embodiment of the present invention, the connection plate 1140 is coupled to the power supply substrate 1160 using a screw 1170. Thus, the connection terminal 1156 exposed at the bottom surface of the connection plate 1140 contacts the connection portions 1166. When the screw 1170 is taken out from the connection plate 1140 and the power supply substrate 1160, the connection plate 1140 is separated from the power supply substrate 1160. The lamp holders 1150 are detachably coupled to the fixing holes 1141 of the connection plate 1140.

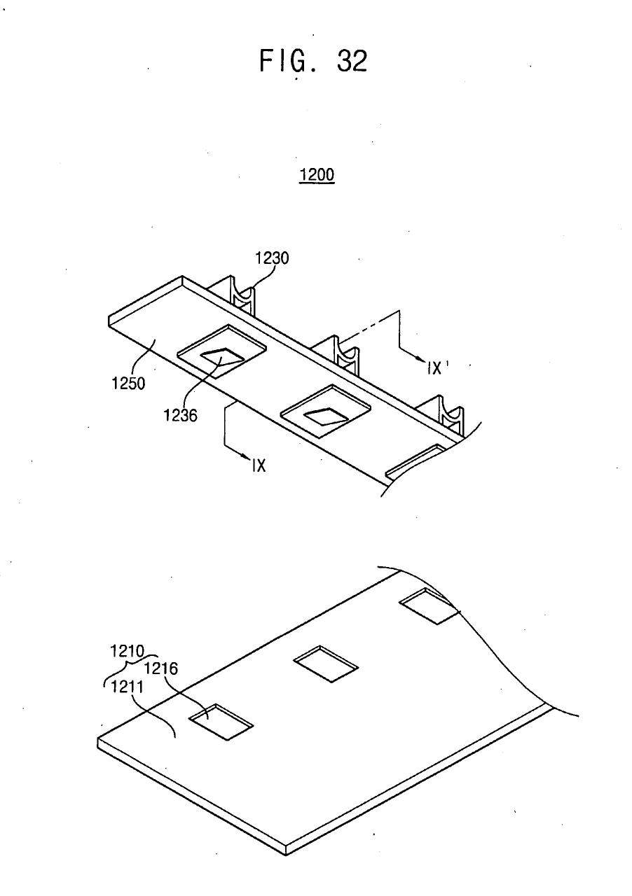

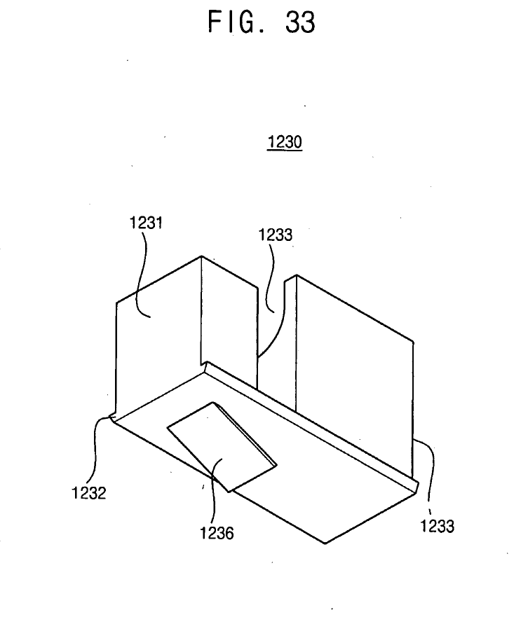

FIG. 32 is an exploded perspective view illustrating a power supply module in accordance with an embodiment of the present invention, and FIG. 33 is a perspective view illustrating the lamp holder of FIG. 32.

Referring to FIGS. 32 and 33, a power supply module 1200 includes a power supply substrate 1210, a connection plate 1250 and a lamp holder 1230. The power supply module 1200 has a construction that is substantially the same as that of the power supply module 1100 described in reference to FIGS. 27 to 31, except for the lamp holder 1230.

The lamp holder 1230 includes a body 1231 and a power supply member. The lamp holder 1230 may have a structure that is substantially the same as that of the lamp holder 1150 described in reference to FIGS. 27 to 31, except for the power supply member.

The power supply member includes a connection terminal 1236 and power supply terminals. The power supply member has a structure that is substantially the same as that of the power supply member 1155, except for the connection terminal 1236.

The connection terminal 1236 is protrudes downward from the lower portion of the body 1231 of the lamp holder 1230. A tension is applied to the connection terminal 1236, perhaps with a spring mechanism. For example, the connection terminal 1236 may bee a spring-loaded plate. The connection terminal 1236, in its neutral position, may form a predetermined inclination angle relative to bottom surface of the body 1231.

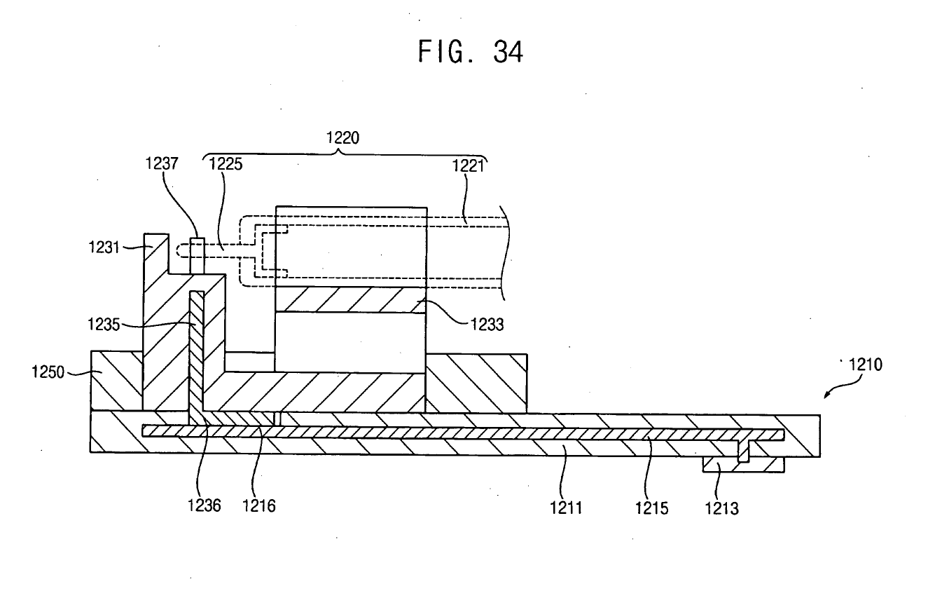

FIG. 34 is a cross-sectional view illustrating the power supply module taken along the line IX-IX′ in FIG. 32.

Referring to FIGS. 32 to 34, when the connection plate 1250 is combined with the insulation substrate 1211, the connection terminal 1236 of the power supply member 1235 contacts the connection portion 1216 formed on the insulation substrate 1211, and the connection terminal 1236 is pressed against the bottom surface of the body 1231. When the connection plate 1250 is separated from the insulation substrate 1211, the connection terminal 1236 is returned to the neutral position by the elasticity of the spring mechanism.

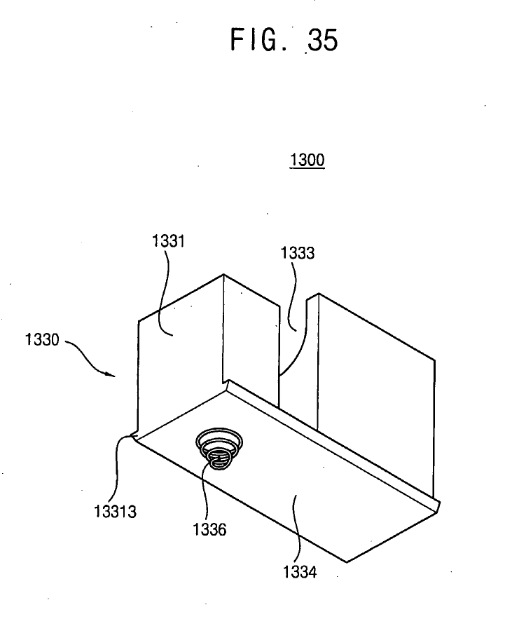

FIG. 35 is a perspective view illustrating a lamp holder in accordance with an embodiment of the present invention.

Referring to FIG. 35, a power supply module 1300 includes a power supply substrate, a connection plate and a lamp holder 1330. The power supply module 1300 has a construction that is substantially the same as that of the power supply module 1100 described in reference to FIGS. 27 to 31.

The lamp holder 1330 includes a body 1331 and a power supply member. The lamp holder 1330 has a structure that is substantially the same as that of the lamp holder 1150 described in reference to FIGS. 27 to 31, except for the power supply member.

The power supply member includes a connection terminal 1336 and a power supply terminal. The power supply member has a structure that is substantially the same as that of the power supply member 1155 described in reference to FIGS. 30 and 31, except for the connection terminal 1336.

The connection terminal 1336 may be spring-loaded, for example shaped like a coil spring. The connection terminal 1336 protrudes from a lower portion of the body 1331 of the lamp holder 1330.

In an embodiment of the present invention, the connection plate (not shown) includes a conductive member exposed at the top surface and the bottom surface of the connection plate. Here, the lamp holder 1330 is installed on the connection plate so that the lamp holder 1330 is electrically connected to the conductive member.

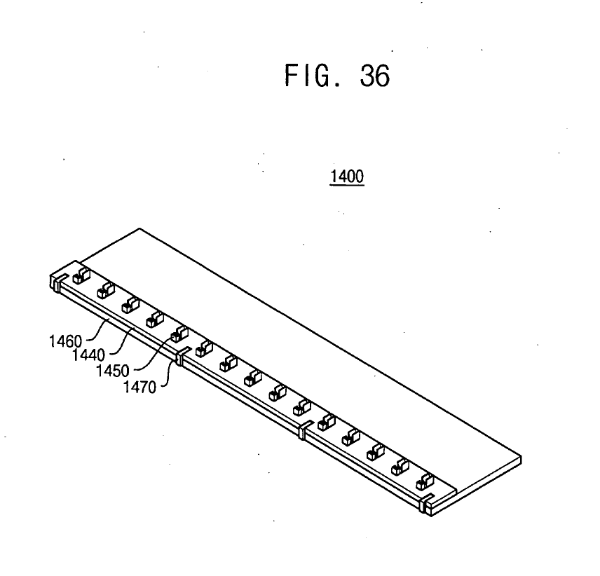

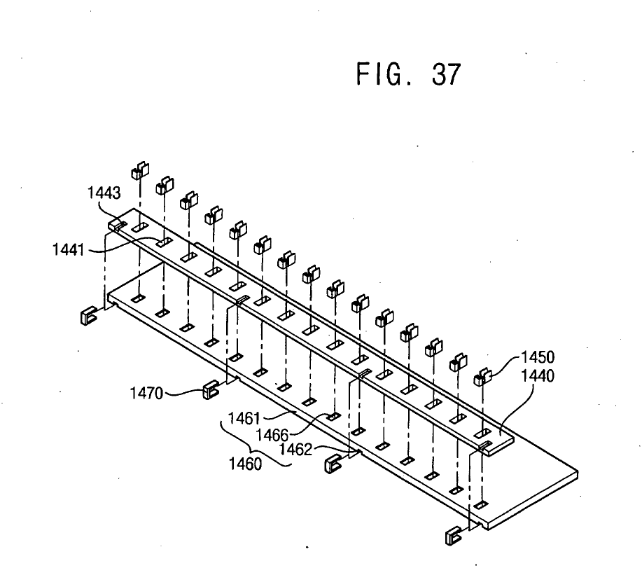

FIG. 36 is a perspective view illustrating a power supply module in accordance with an embodiment of the present invention, and FIG. 37 is an exploded perspective view illustrating the power supply module of FIG. 36.

Referring to FIGS. 36 and 37, a power supply module 1400 includes a power supply substrate 1460, a connection plate 1440, a lamp holder 1450, and a coupling member 1470. The power supply module 1400 may have a construction that is substantially the same as that of the power supply module 1100 described in reference to FIGS. 27 to 31, except for the coupling member 1470 and the grooves formed on the connection plate 1440 and the power supply substrate 1460. The coupling member 1470 is inserted in the grooves.

The connection plate 1440 has a plurality of first grooves 1443. Each of the first grooves 1443 is formed between fixing holes 1441 of the connection plate 1440. The first grooves 1443 have a predetermined depth measured from the top surface of the connection plate 1440.

The power supply substrate 1460 includes an insulation substrate 1461, power supply devices and a conductive wiring. The power supply substrate 1460 has a construction that is substantially the same as that of the power supply substrate 1160 described in reference to FIGS. 27 to 31, except for the insulation substrate 1461.

The insulation substrate 1461 has a plurality of second grooves 1462 positioned to align with the first grooves 1443 of the connection plate 1440 upon assembly. The second grooves 1462 have a predetermined depth measured from a bottom surface of the insulation substrate 1461.

The coupling member 1470 combines the connection plate 1440 with the insulation substrate 1461. The coupling member 1470 is substantially “C”-shaped as shown in FIGS. 36 and 37. The coupling member 1470 presses together the base portion of the first grooves 1443 and the second grooves 1462 such that the connection plate 1440 contacts the insulation substrate 1461. Hence, the connection terminal of the power supply member contacts a connection portion 1466 on the insulation substrate 1461.

In an embodiment of the present invention, the coupling member 1470 includes an adhesive tape. The adhesive tape may be interposed between the insulation substrate 1461 and the connection plate 1440 to combine the insulation substrate 1461 with the connection plate 1440.

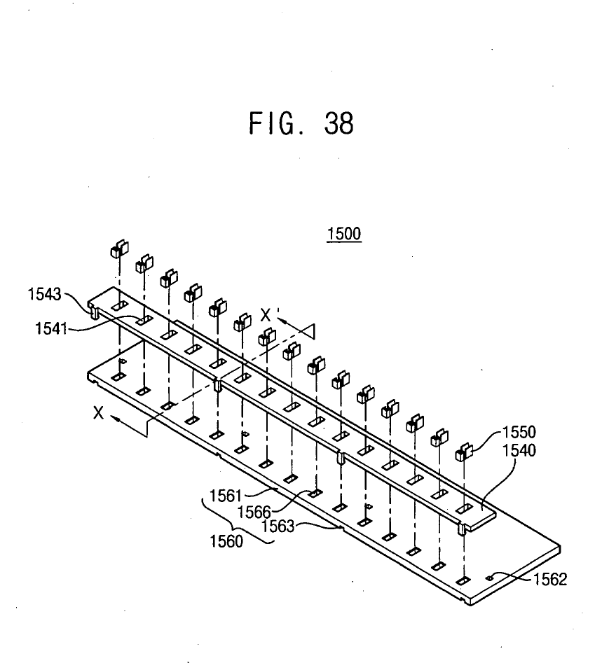

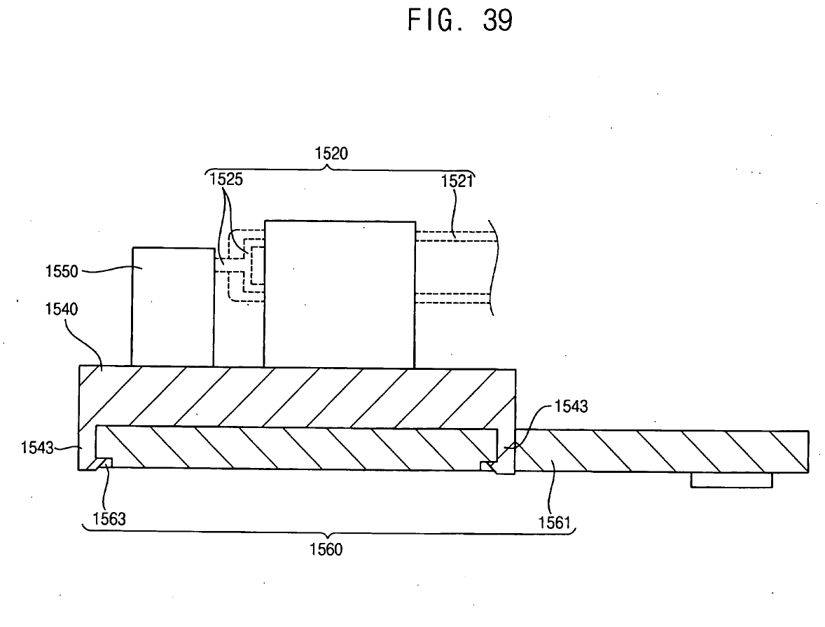

FIG. 38 is a perspective view illustrating a power supply module in accordance with an embodiment of the present invention, and FIG. 39 is a cross-sectional view illustrating the power supply module taken along the line X-X′ of FIG. 38.

Referring to FIGS. 38 and 39, a power supply module 1500 includes a power supply substrate 1560, a connection plate 1540 and a lamp holder 1550. The power supply module 1500 may have a construction that is substantially the same as that of the power supply module 1100 described in reference to FIGS. 27 to 31, except for the connection plate 1540 and the power supply substrate 1560.

The connection plate 1540 may have a structure substantially the same as that of the connection plate 1140 described in reference to FIGS. 27 and 28, except for the presence of a coupling protrusion 1543 without a female screw portion. Where there is more than one of the coupling protrusion 1543, the coupling protrusions are disposed at an edge portion of the connection plate 1540 along the length of the connection plate 1540.

The power supply substrate 1560 includes an insulation substrate 1561, power supply devices and a conductive wiring. The power supply substrate 1560 may have a construction substantially the same as that of the power supply substrate 1160 described in reference to FIGS. 27 and 28, except for the insulation substrate 1561.

The insulation substrate 1561 has a construction that is substantially the same as that of the power supply substrate 1161 described in reference to FIGS. 27 and 28, except for a plurality of coupling holes 1562 without female screw portions.

The coupling holes 1562 are formed on the insulation substrate 1561. The insulation substrate 1561 has a plurality of grooves 1563 along its edge portion. The grooves 1563 have a predetermined depth measured from the bottom surface of the insulation substrate 1561.

When the coupling protrusions 1543 are inserted into the coupling holes 1562 and the coupling protrusions 1543 are caught on the grooves 1563, the connection plate 1540 is combined with the power supply substrate 1560. Thus, the connection terminal of the power supply member contacts the connection portion 1566 on the top surface of the insulation substrate 1561.

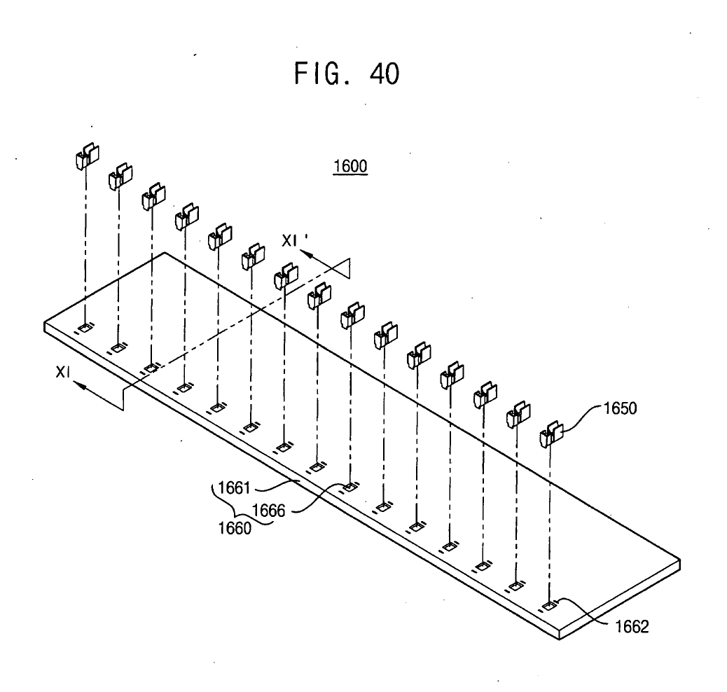

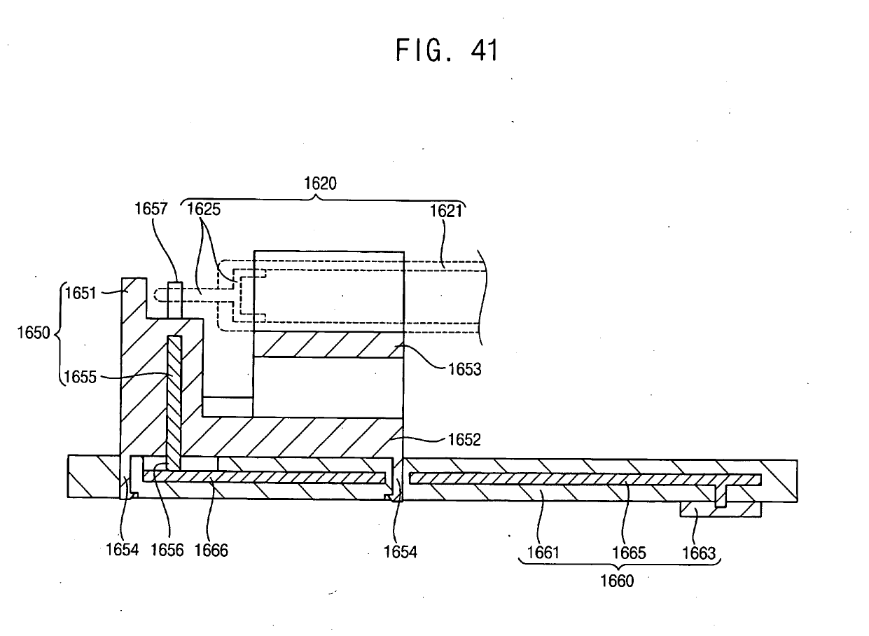

FIG. 40 is an exploded perspective view illustrating a power supply module in accordance with an embodiment of the present invention, and FIG. 41 is a cross-sectional view illustrating the power supply module taken along the line XI-XI′ in FIG. 40.

Referring to FIGS. 40 and 41, a power supply module 1600 includes a lamp holder 1650 and a power supply substrate 1660. The power supply module 1600 has a construction that is substantially the same as that of the power supply module 1100 described in reference to FIGS. 27 to 31, except for the lamp holders 1650 and an insulation substrate 1661 without the connection plate 1140.

The lamp holder 1650 includes a body 165i and a power supply member 1655. The lamp holder 1650 has a structure that is substantially the same as that of the lamp holder 1150 described in reference to FIGS. 27 to 31, except for the body 1651.

The body 1651 of the lamp holder 1650 has a structure that is substantially the same as that of the body 1151 of the lamp holders 1150 described in reference to FIGS. 27 to 31, except for coupling hooks 1654 without the protrusions.

The power supply substrate 1660 includes the insulation substrate 1661, power supply devices 1663 and a conductive wiring 1665. The power supply substrate 1660 may have a structure that is substantially the same as that of the power supply substrate 1160 described in reference to FIGS. 27 to 31, except for the insulation substrate 1661.

The insulation substrate 1661 may have a structure substantially the same as that of the insulation substrate 1161 described in reference to FIGS. 27 to 31, except for a coupling hole 1662 where the coupling hook 1654 is inserted. The coupling hole 1662 is formed in parts of the insulation substrate 1661 and is adjacent to the connection portion 1666.

When the coupling hook 1654 is inserted into the coupling holes 1662, the lamp holder 1650 is fixed to the insulation substrate 1661. A connection terminal 1656 of the power supply member 1655 protrudes from a lower portion of the body 1651 to contact a connection portion 1666 of the insulation substrate 1661. Thus, the power supply substrate 1660 provides a lamp fixed to the lamp holder 1650 with voltages.

As described above, the connection plate may be combined with the power supply substrate by a coupling member. When a coupling member is used, the power supply substrate may be detached from the power supply module without separating the lamps from the lamp holders. This method of detaching improves rework efficiency.

Backlight Assembly

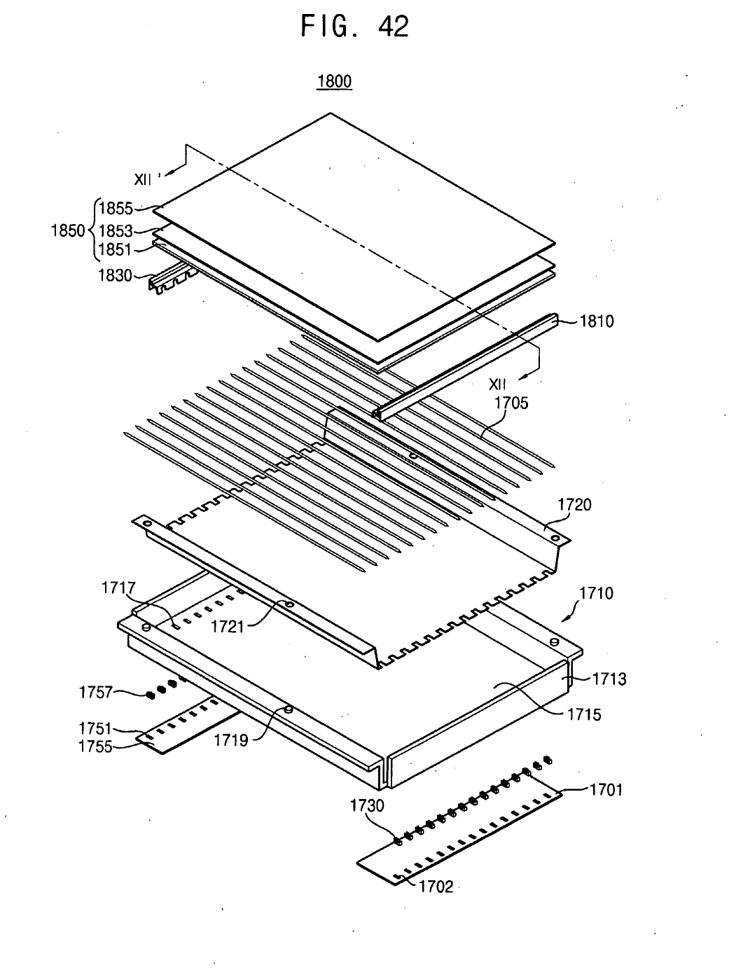

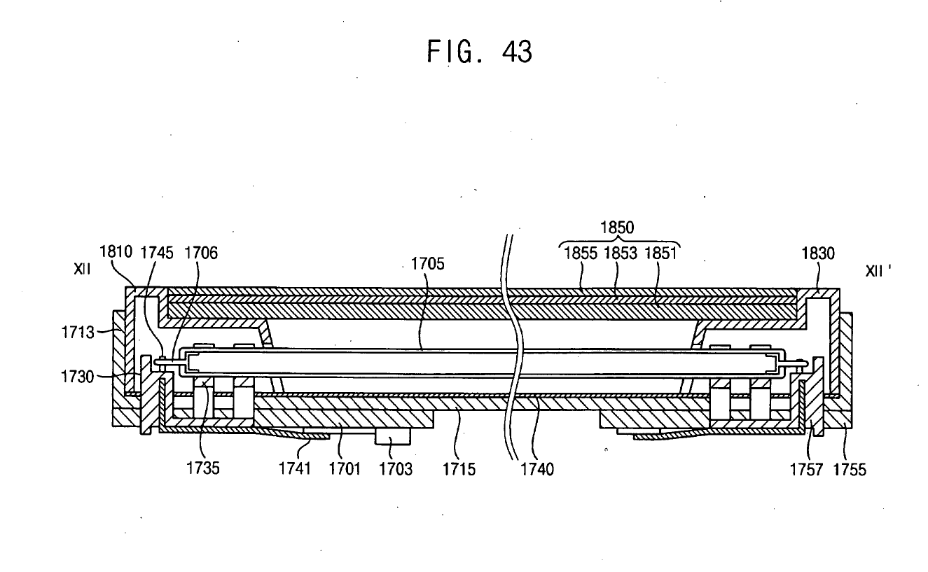

FIG. 42 is an exploded perspective view illustrating a backlight assembly in accordance with an embodiment of the present invention, and FIG. 43 is a cross-sectional view illustrating the backlight assembly taken along the line XII-XII′ in FIG. 42.

Referring to FIGS. 42 and 43, a backlight assembly 1800 includes a receiving container 1710, a plurality of lamps 1705, first lamp holders 1730 and a power supply substrate 1701.

The receiving container 1710 includes a bottom plate 1715 and side walls 1713 extending from the edge portions of the bottom plate 1715. A plurality of first openings (not shown) formed on the bottom plate 1715 adjacent to the side walls 1713. A plurality of second openings 1717 are formed on the bottom plate 1715 arranged parallel to the first openings. The lamps 1705 are disposed on the bottom plate 1715.

The power supply substrate 1701 is a plate. The power supply substrate 1701 is disposed beneath a bottom surface of the bottom plate 1715. The power supply substrate 1701 has a first surface facing the bottom surface of the bottom plate.1715, and a second surface in a plane parallel to the first surface. The power supply substrate 1701 includes first fixing holes 1702 positioned to align with the first openings.

The first lamp holders 1730 have a structure that is substantially the same as those of the lamp holders 1150 described in reference to FIGS. 27 to 31. The first lamp holders 1730 are inserted into the first openings after the first lamp holders 1730 are inserted into the first fixing holes 1702. Power supply members 1745 of the first lamp holders 1730 include connection terminals 1741 and power supply terminals. The connection terminals 1741 may be directly connected to connection pads formed on the second surface of the power supply substrate 1701. In some embodiments, the connection terminals 1741 may be connected to the connection pads by a soldering method.

The lamps 1705 are fixed to the lamp holders 1730 exposed through the first openings. First end portions of the lamps 1705 are guided by lamp support grooves 1735 of the lamp holders 1730, and first lamp leads 1706 are coupled to the power supply member 1745 of the lamp holders 1730. This way, the power supply substrate 1701 may provide the lamps 1705 with voltages.

The backlight assembly 1800 further includes second lamp holders 1757 and a ground substrate 1755. The second lamp holders 1757 may have a structure that is substantially the same as those of the first lamp holders 1730.

Second leads of the lamps 1705 are grounded through the ground substrate 1755. In an embodiment of the present invention, the ground substrate 1755 may serve as the power supply substrate 1701 that applies the voltages to the lamps 1705.

The ground substrate 1755 has second fixing holes 1751 where the second lamp holders 1757 are inserted. After the second lamp holders 1757 are inserted into the second fixing holes 1751, the second lamp holders 1757 are inserted into the second openings 1717 of the bottom plate 1715. Connection terminals 1741 of the second lamp holders 1757 may contact the connection pads formed on a bottom surface of the ground substrate 1755. In some embodiments, the connection terminals 1741 may be connected to the connection pads by a soldering method.

The lamps 1705 are fixed to the second lamp holders 1757 that extend through the second openings 1717. Second end portions of the lamps 1705 are guided by the lamp support grooves of the second lamp holder 1757, and second leads of the lamps 1705 are inserted into power supply terminals of the second lamp holder 1757.

The backlight assembly 1800 further includes a reflective sheet 1720, a first side mold 1810, a second side mold 1830 and an optical sheet unit 1850.

The reflective sheet 1720 is disposed on the bottom plate 1715 to reflect the light from the lamps 1705 back toward the top surface. The reflective sheet 1720 extends over and along the side walls 1713 of the receiving container 1710. The reflective sheet 1720 has holes 1721 where protrusions 1719 formed on the side walls 1713 are inserted.

The first side mold 1810 is disposed on the bottom plate 1715 to cover the first lamp holders 1730. The first side mold 1810 extends along the side walls 1713 in a direction substantially perpendicular to the length of the lamps 1705. The first side mold 1810 includes two supporting walls contacting the bottom plate 1715 and a connector connecting the supporting walls. The connector has a stepped portion. One of the supporting walls separated from the side walls 1713 has grooves to accommodate the lamps 1705.

The second side mold 1830 is disposed on the bottom plate 1715 to cover the second lamp holders 1757. The second side mold 1830 has a construction that is substantially the same as that of the first side mold 1810.

The optical sheet unit 1850 improves the optical characteristics of the light received from the lamps 1705. Particularly, the optical sheet unit 1850 is useful for improving luminance uniformity and front luminance. The optical sheet unit 1850 includes a diffusion plate 1851 and condensing sheets 1853 and 1855.

The diffusion plate 1851 diffuses the light from the lamps 1705 to improve luminance uniformity. The diffusion plate 1851 is positioned on the stepped portions of the connectors in the first and the second side molds 1810 and 1830.

The condensing sheets 1853 and 1855 collect the light from the diffusion plate 1851 and adjust its direction of propagation to improve the front luminance. For example, one of the condensing sheets 1853 and 1855 may collect the light along a first direction whereas the other of the condensing sheets 1853 and 1855 may condense the light in a second direction substantially perpendicular to the first direction.

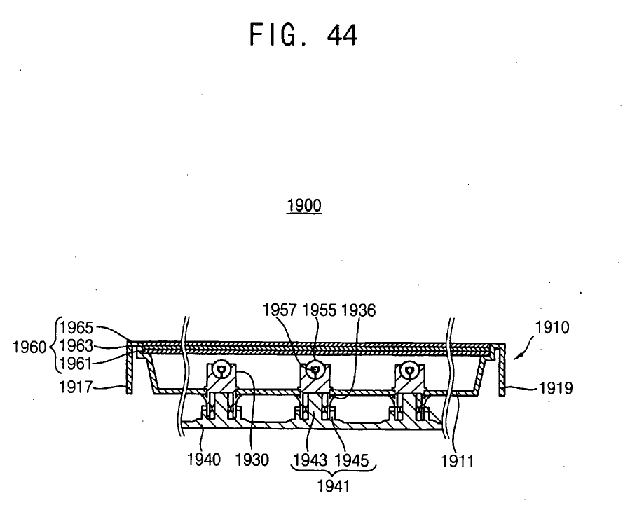

FIG. 44 is a cross-sectional view illustrating a backlight assembly in accordance with an embodiment of the present invention.

Referring to FIG. 44, a backlight assembly 1900 includes a receiving container 1910, lamp holders 1930, a power supply substrate 1940 and lamps 1955.

The receiving container 1910 includes a bottom plate 1911 and side walls 1917 and 1919. A plurality of openings are provided through the bottom plate 1911.

The lamp holders 1930 and the power supply substrate 1940 have structures that are substantially the same as those of the lamp holders 1030 and the power supply substrate 1040 described in reference FIGS. 21 to 26.

The power supply substrate 1940 has fixing portions 1941 at a top surface for fixing the lamp holders 1930 in position. The fixing portions 1941 include first protruding portions 1943 and second protruding portions 1945. Connection portions of the power supply substrate 1940 are protruded from the first protruding portions 1943.

Each of the lamp holders 1930 includes a body and a power supply member, similarly to the lamp holder 30 of FIG. 1. The body has a coupling groove into which one of the first protruding portions 1943 is inserted upon assembly. The body also has fixing hooks 1936 at lateral portions thereof.

Each of the power supply members includes a connection terminal and a power supply terminal, similarly to the power supply member 430 of FIG. 9. The connection terminal extends inside of the coupling groove and contacts the connection pad on the power supply substrate. The power supply terminal extends over the upper portion of the body. The lamp holder 1930 is inserted into one of the openings in the bottom plate 1911 after the lamp holder 1930 is received in the fixing portion 1941.

The lamps 1955 are disposed on the bottom plate 1911 and fixed to the lamp holders 1930. End portions of the lamps 1955 are guided by lamp support grooves on the bodies of the lamp holders 1930, and lamp leads 1957 extend into the power supply terminals of the power supply members. Hence, voltages may be applied to the lamps 1955 through the power supply substrate 1940.

The backlight assembly 1900 further includes an optical sheet unit 1960. The optical sheet unit 1960 is substantially the same as the optical sheet unit 1850 described in reference to FIGS. 42 and 43.

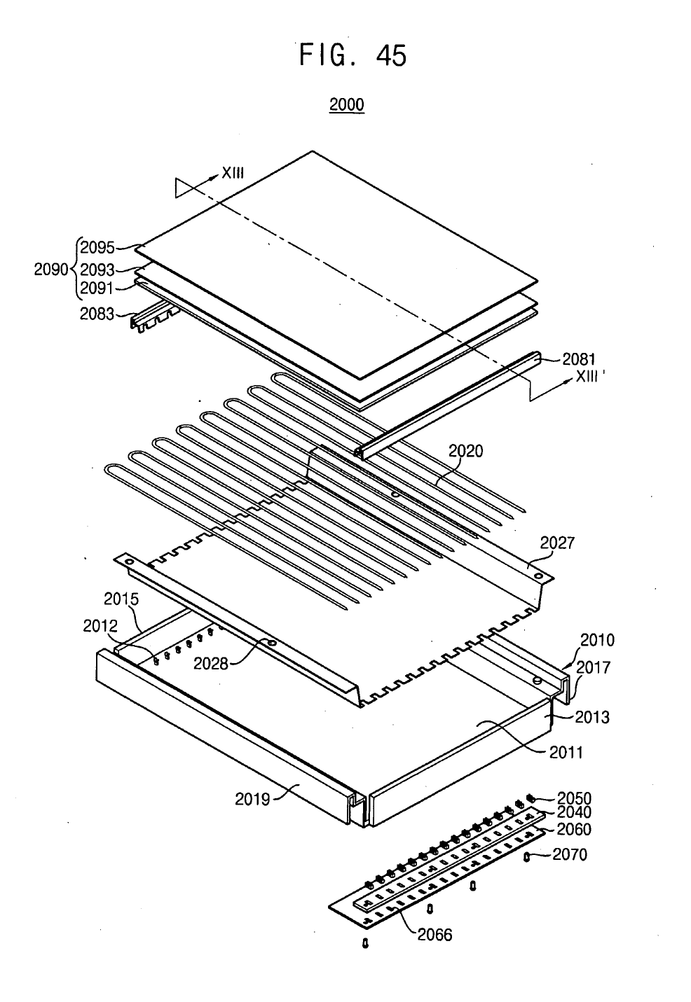

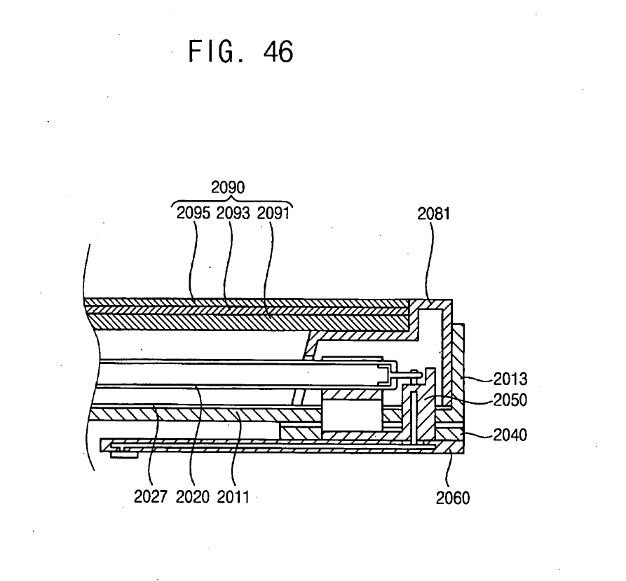

FIG. 45 is an exploded perspective view illustrating a backlight assembly in accordance with an embodiment of the present invention, and FIG. 46 is a cross-sectional view illustrating the backlight assembly taken along the line XIII-XIII′ in FIG. 45.

Referring to FIGS. 45 and 46, a backlight assembly 2000 includes a receiving container 2010, a plurality of lamps 2020, a plurality of lamp holders 2050, connection plates 2040 and a power supply substrate 2060.

The receiving container 2020 may be substantially the same as the receiving container 1710 described in reference to FIGS. 42 and 43, except for fixing protrusions 2012 formed on a bottom plate 2011.

The lamps 2020 may have structures substantially the same as those of the lamps 1705 described in reference to FIGS. 42 and 43, except for the lamp tubes. The lamp tubes are substantially U-shaped. First leads and second leads are formed at end portions of the lamps 2020. The first and the second leads of the lamps 2020 are disposed adjacent to a first side wall 2013 of the receiving container 2010. Bending portions of the lamps 2020 hook around the fixing protrusions 2012.

The lamp holders 2050, the connection plates 2040 and the power supply substrate 2060 may have constructions substantially the same as those of the lamp holders 1150, the connection plate 1140 and the power supply substrate 1160 described in reference to FIGS. 27 to 31.

A conductive wiring is partially exposed on a top surface of the power supply substrate 2060 to provide connection portions. The lamp holders 2050 are inserted into fixing holes in the connection plates 2040. Each of the lamp holders 2050 includes a body and a power supply member. The power supply member extends from an upper portion of the body to a lower portion. The power supply member includes a connection terminal exposed at the lower portion of the body and a power supply terminal that protrudes at the upper portion of the body. The lamp holders 2050 are inserted into openings in the bottom plate 2011 of the receiving container 2010 after being fixed to the connection plates 2040.

The power supply substrate 2060, the connection plates 2040 and the bottom plate 2011 may be combined with one another using a coupling member such as a screw 2070. The connection terminal of each of the lamp holders 2050 exposed at a bottom surface of the connection plate 2040 directly contacts one of the connection portions formed on the power supply substrate 2060.

In an embodiment of the present invention, the connection plates 2040 and the power supply substrate 2060 are combined with one another using a coupling member such as a fixing clip before being fixed to the bottom plate 2011.

The backlight assembly 2000 further includes a reflective sheet 2027, a first side mold 2081, a second side mold 2083 and an optical sheet unit 2090. The reflective sheet 2027, the first side mold 2081, the second side mold 2083 and the optical sheet unit 2090 are substantially the same as the reflective sheet 1720, the first side mold 1810, the second side mold 1830 and the optical sheet unit 1850 described in reference to FIGS. 42 and 43.

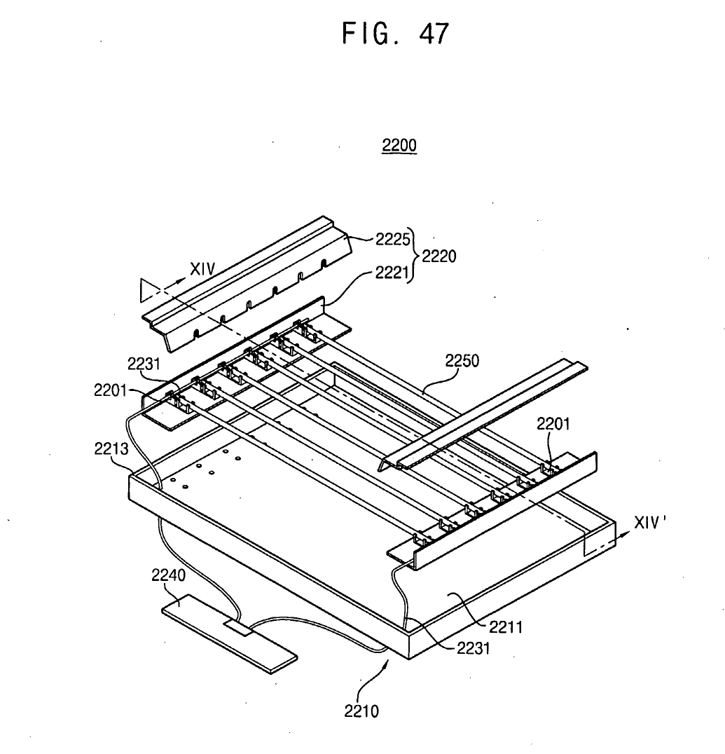

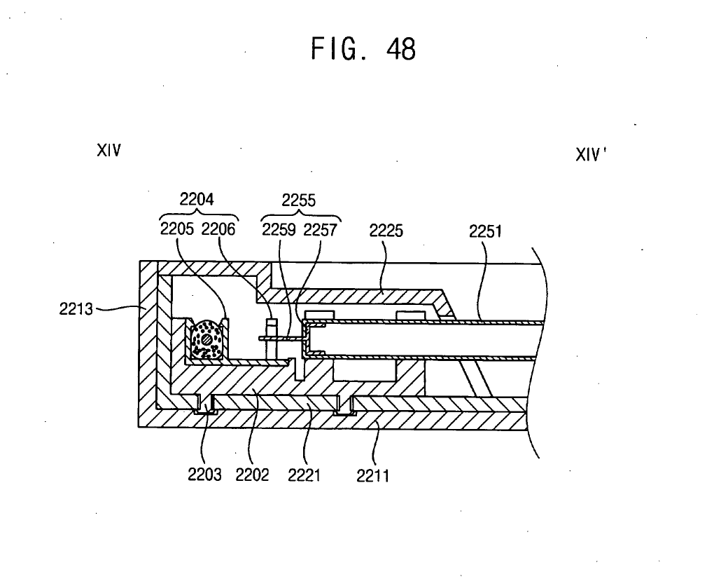

FIG. 47 is an exploded perspective view illustrating a backlight assembly in accordance with an embodiment of the present invention, and FIG. 48 is a cross-sectional view illustrating the backlight assembly taken along the line XIV-XIV′ in FIG. 47.

Referring to FIGS. 47 and 48, a backlight assembly 2200 includes a receiving container 2210, a power supply substrate 2240, a plurality of lamps 2250, a voltage supply wire 2231 and lamp holders 2201.

The power supply substrate 2240 is disposed on a bottom plate 2211 of the receiving container 2210 so as to provide the voltages to the lamps 2250. A connection pad may be provided on the power supply substrate 2240 to connect to the voltage supply wire 2231. The lamps 2250 are also disposed on the bottom plate 2211.

The lamp holders 2201 are disposed on the bottom plate 2211 along the side walls of the receiving container 2210. Each of the lamp holders 2201 includes a body 2202 and a power supply member 2204. The lamp holders 2201 may be substantially the same as the lamp holders 200 described in reference to FIG. 5, except for a fixing protrusion 2203 formed at a lower portion of the body 2202. The power supply member 2204 includes a first clip 2205 and second clip 2206.

The voltage supply wire 2231 provides voltages to the lamps 2250. The lamps 2250 are connected to the power supply substrate 2240 in parallel. Particularly, the voltage supply wire 2231 is electrically connected to the connection pad and extends to the inside of the receiving container 2210 through an opening of the bottom plate 2211.

The lamp holders 2201 are arranged along the voltage supply wire 2231 separated by a predetermined interval. The voltage supply wire 2231 is connected to the first clips 2205 of the lamp holders 2201 by a pressure welding method.

End portions of the lamp tubes 2251 are held by the lamp support grooves of the lamp holders 2201, and lamp leads 2259 extend from the electrodes 2255 are inserted and fixed to the second clips 2206. This arrangement allows a plurality of lamps 2250 to be serially operated using one power supply substrate 2240.

The backlight assembly 2200 further includes a side mold 2220. The side mold 2220 covers the lamp holders 2201 and supports an optical sheet unit. The side mold 2220 includes a lower side mold 2221 and an upper side mold 2225.

The lower side mold 2221 may have a substantially L-shaped cross section. The lower side mold 2221 is disposed on the bottom plate 2211 along the side wall 2213 of the receiving container 2210. The lamp holders 2201 are arranged on the lower side mold 2221 separated by a predetermined interval.

In an embodiment of the present invention, the lower side mold 2221 is integrally formed with the lamp holders 2201.

The upper side mold 2225 is combined with the lower side mold 2221 to protect the lamp holders 2201. The upper side mold 2225 has a stepped portion at the top. The optical sheet (not shown) is disposed on the stepped portion of the upper side mold 2225.

According to the backlight assembly as described above, the lamp holders may be inserted into the openings in the bottom plate during the assembly process combining the lamp holders with the power supply substrate or the connection plate. Alternatively, the lamp holders may be detachably combined with the voltage supply wire without being directly coupled to the bottom plate of the receiving container. Therefore, the backlight assembly may be more efficiently fabricated without a process for fixing the lamp holders to the bottom plate of the receiving container.

Display Device

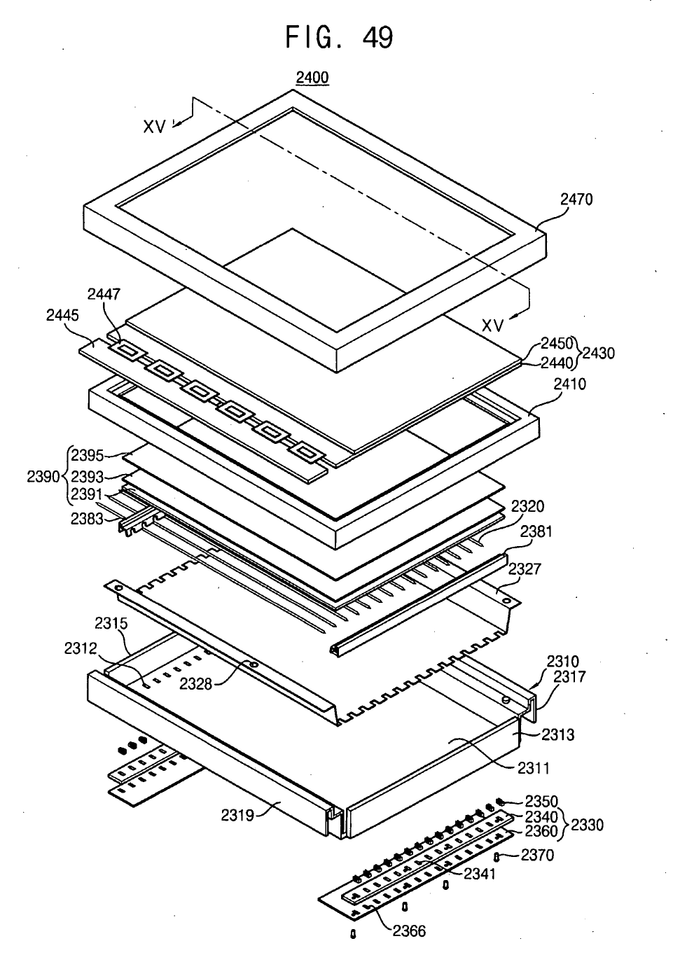

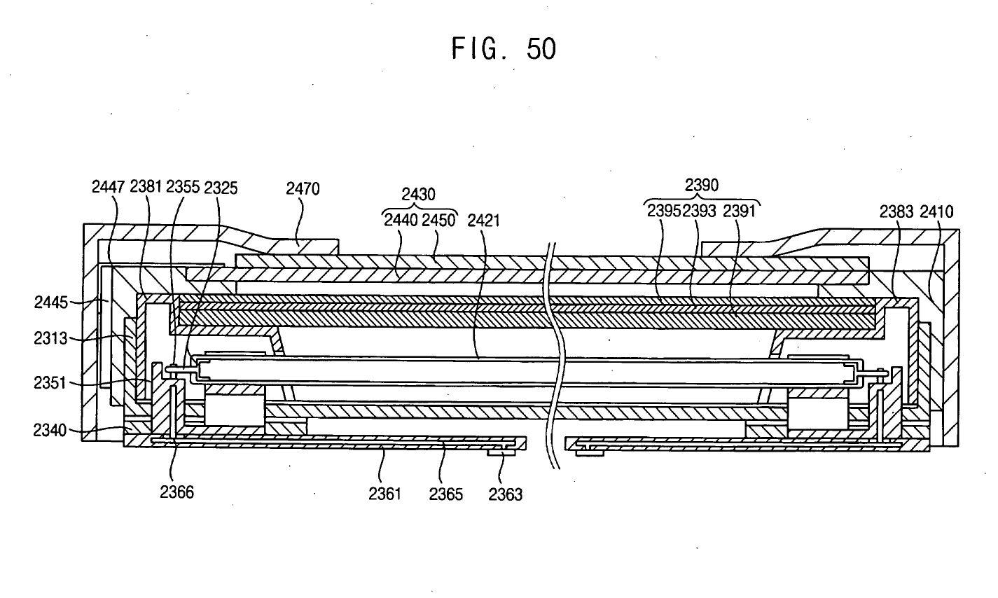

FIG. 49 is an exploded perspective view illustrating a display device in accordance with an embodiment of the present invention, and FIG. 50 is a cross-sectional view illustrating the backlight assembly taken along the line XV-XV′ in FIG. 49.

Referring to FIGS. 49 and 50, a display device 2400 includes a receiving container 2310, a plurality of lamps 2320, a plurality of lamp holders 2350, a power supply unit 2330 and a display panel 2430.

The receiving container 2310 and the lamps 2320 may be substantially the same as the receiving container 1710 and the lamps 1705 described in reference to FIG. 42. In addition, the lamp holders 2350 may be substantially the same as the lamp holders 2050 described in reference to FIGS. 45 and 46.

Each of the lamp holders 2350 includes a body 2351 and a power supply member 2355. The body 2351 is inserted into an opening 2312 formed in a bottom plate 2311 of the receiving container 2310. The power supply member 2355 includes a connection terminal and a power supply terminal. The connection terminal is fixed to the body 2351 and exposed from a bottom surface of the bottom plate 2311. The power supply terminal extends over a top surface of the bottom plate 2311 to fix an electrode 2325 in place.

The power supply unit 2330 provides voltages to the lamps 2320 through the lamp holders 2350. The power supply unit 2330 includes a fixing portion and a connection portion 2366. The lamp holders 2350 are fixed to the fixing portion of the power supply unit 2330. The connection portion 2366 directly contacts the connection terminal of the lamp holders 2350.

The power supply unit 2330 includes a connection plate 2340 and a power supply unit 2360. The connection plate 2340 and the power supply substrate 2360 are substantially the same as the connection plate 2040 and the power supply substrate 2060 described in reference to FIGS. 45 and 46.

The connection plate 2340 is disposed between the power supply substrate 2360 and the bottom plate 2311. The fixing portion includes a fixing hole 2341 formed in the connection plate 2340. A conductive wiring 2365 is partially exposed on a top surface of the power supply substrate 2360 to provide the connection portion 2366 on the power supply substrate 2360.

In an embodiment of the present invention, the power supply unit 2330 may include an insulation substrate and a conductive wiring. The insulation substrate may have fixing portions that are substantially the same as the fixing portions 1041 described in reference to FIGS. 21 to 26. Portions of the conductive wiring may protrude from lateral portions of the fixing portions so that connection pads may be provided on the insulation substrate.

In an embodiment of the present invention, the fixing portions may be formed on the insulation substrate. The fixing portions may include fixing holes substantially the same as the fixing holes 611 described in reference to FIG. 15. The conductive wiring may be partially exposed on a bottom face of the insulation substrate so that the connection portions 2366 are provided on the insulation substrate. The connection terminals of the lamp holders 2350 may be exposed from the bottom face of the insulation substrate, contacting the connection portions 2366. Alternatively, the connection terminals may be connected to the connection portions 2366 by a soldering method.

The display device 2400 further includes a reflective sheet 2327, a first side mold 2381, a second side mold 2383, an optical sheet unit 2390 and a middle side mold 2410. The reflective sheet 2327, the first side mold 2381, the second side mold 2383 and the optical sheet unit 2390 may have constructions substantially the same as those of the reflective sheet 1720, the first side mold 1810, the second side mold 1830 and the optical sheet unit 1850 described in reference to FIGS. 42 and 43.

The middle mold 2410 covers a peripheral portion of the optical sheet unit 2390 and combines with the receiving container 2310. The middle mold 2410 has a stepped portion formed on an upper face thereof. The display panel 2430 is disposed on the stepped portion.

The display device 2400 displays an image based on the light generated from the lamps 2320 and transmitted through the optical sheet unit 2390. The display panel 2430 is disposed on the middle mold 2410. The display panel 2430 includes a first substrate 2440, a second substrate 2450 and a liquid crystal layer interposed between the first and the second substrates 2440 and 2450.

Electrodes are provided between the first and the second substrates 2440 and 2450 to control the liquid crystal layer. Data voltages for generating electric fields between the electrodes are applied to the first substrate 2440 through a printed circuit board (PCB) 2445 and a flexible PCB 2447. The electric fields may adjust an amount of the light passing through the display panel 2430 by re-arranging the liquid crystal layer. Thus, the display device 2400 may display a required image through the display panel 2430.

The display device 2400 further includes a top chassis 2470 that covers a peripheral portion of the display panel 2430 to expose an effective display area of the display panel 2430.

According to the present invention, a securing portion formed at an end portion of a lead of a lamp may prevent separation of the lamp from a conductive clip of a lamp holder along a direction substantially parallel to a length of the lamp. Thus, the lamp may be firmly combined with the lamp holder.

As described above, a voltage supply wire and an electrode of the lamp may be coupled with a power supply member of the lamp holder to prevent an electrical short between the lamp and the voltage supply wire. The lamp is easily assembled with the lamp holder.

Since the lamp holder may include a conductive adhesion member or a connection terminal having more than two divided connection terminal portions, the lamp lead may move while a secure electrical connection between the lead and a power supply terminal of the lamp holder is sufficiently ensured. Hence, damage to the lamp and/or the lamp holder caused by an external impact may be effectively prevented.

The lead of the lamp may be detachably connected to the power supply terminal of the lamp holder and the connection terminal of the lamp holder may be directly contacted with a connection portion of a power supply substrate. Therefore, electrical connections among the lamp, the lamp holder and the power supply substrate may be greatly enhanced without any soldering method. Also, a backlight assembly or a power supply module including a lamp, the lamp holder and the power supply substrate may be easily fabricated.

Because a connection plate may be easily separated from the power supply substrate, the power supply substrate may be separated from the power supply module or the backlight assembly without detaching the lamps from the lamp holders. Hence, rework efficiency for the power supply module or the backlight assembly may be improved.

A plurality of lamp holders may be combined with a receiving container while the lamp holders are assembled with the power supply substrate or the connection plate without coupling the lamp holders to the bottom plate of the receiving container. Therefore, the backlight assembly and a display device including these elements may be more efficiently fabricated without a process for fixing the lamp holders to the bottom plate of the receiving container.

As a result, the power supply module, the backlight assembly and the display device may be efficiently fabricated to ensure improved reliability even after receiving an external impact.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. For example, different embodiments of the lamps, lamp holders, power supply modules, backlight assemblies, and display panel described herein may be “mixed and matched” to the extent that doing so is suitable.

It is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

What is claimed is:

1. A lamp comprising:
a lamp tube containing a discharging gas;
an electrode disposed at an end portion of the lamp tube inside the lamp tube; and
a lamp lead including a connection portion and a securing portion, wherein the connection portion extends from the electrode to the securing portion, wherein the securing portion is located outside the lamp tube.

2. The lamp of claim 1, wherein the securing portion has a larger cross-section than the connection portion, the cross-section being substantially perpendicular to a length of the lamp tube.

3. The lamp of claim 2, wherein the securing portion has a spherical shape.

4. The lamp of claim 2, wherein the securing portion has a chamfer shape with a cross-section that gradually increases with distance from the lamp tube.

5. A lamp holder comprising:
a body including a lamp support portion capable of supporting an end portion of a lamp; and
a power supply member fixed to the body and welded to a voltage supply wire for providing a voltage to an electrode that is disposed at the end portion of the lamp.

6. The lamp holder of claim 5, wherein the power supply member comprises:
a first clip that is pressure-welded to the voltage supply wire; and
a second clip capable of holding a lamp lead extending from the electrode.

7. The lamp holder of claim 6, wherein the body comprises:
a bottom portion from which the lamp support portion protrudes; and
a wire guide portion protruding from the bottom portion, the second clip being fixed to the wire guide portion.

8. A lamp holder comprising:
a body having a lamp support groove and a receiving space wherein the lamp support groove is formed at a surface of the body adjacent to the receiving space;
a power supply member disposed in the receiving space, wherein the power supply member has a power supply terminal exposed at one end and a connection terminal exposed at another end, the power supply terminal and the connection terminal being electrically coupled; and
a conductive adhesion member covering the power supply member.

9. The lamp holder of claim 8, further comprising a holder cap inserted into the receiving space, the holder cap contacting the conductive adhesion member pressing the conductive adhesion member against the power supply terminal.

10. The lamp holder of claim 9, further comprising:
connection holes formed at lateral portions of the body, wherein the connection holes communicate with the receiving space, the connection holes being formed on two parallel surfaces of the body; and
connection hooks formed at lower portions of the holder cap, wherein the connection hooks are designed to be inserted into the connection holes to securely attach the holder cap to the body.

11. A lamp holder comprising:
a body having a lamp support groove and a receiving space, wherein the lamp support groove is formed at a face of the body adjacent to the receiving space;
a power supply member disposed in the receiving space, wherein the power supply member has a first connection terminal coupled to a second connection terminal and each of the first and the second connection terminals is divided into two connection terminal portions, the four connection terminal portions arranged to securely hold a lamp lead; and
a holder cap inserted in the receiving space, wherein the holder cap connects the power supply member to the lamp lead by pressing the power supply member.

12. A power supply module comprising:
a lamp holder having a body and a power supply member, wherein the power supply member includes a connection terminal coupled to the body and a power supply terminal capable of coupling to a lamp; and
a power supply substrate making contact with the connection terminal.

13. The power supply module of claim 12, wherein the power supply substrate comprises a fixing portion that is useful for coupling the lamp holder to the power supply substrate.

14. The power supply module of claim 13, wherein the fixing portion includes a fixing hole into which the lamp holder is inserted.

15. The power supply module of claim 14, further comprising a connection portion disposed on a surface of the power supply substrate adjacent to the fixing hole.

16. The power supply module of claim 15, wherein the connection terminal is exposed at the surface of the power supply substrate and contacts the connection portion when the lamp holder is inserted into the fixing hole.

17. The power supply module of claim 15, wherein the connection terminal is exposed at the surface of the power supply substrate and soldered with the connection portion.

18. The power supply module of claim 13, wherein the fixing portion comprises:
a first protruding portion capable of being inserted into a connection groove formed at a lower portion of the body of the lamp holder; and
a second protruding portion spaced apart from the first protruding portion, the second protruding portion capable of covering outer sides of the lower portion of the body such that the lower portion of the body is sandwiched between the first protruding portion and the second protruding portion.

19. The power supply module of claim 18, wherein the connection terminal protrudes from an inner wall of the connection groove, further comprising a connection portion disposed on the first protruding portions such that the connection terminal of the lamp holder electrically couples to the connection portion of the power supply substrate when the lamp holder is combined with the power supply substrate.

20. The power supply module of claim 12, further comprising a connection plate having a fixing hole that is capable of receiving the lamp holder and being combined with the power supply substrate.

21. The power supply module of claim 20, wherein the connection terminal includes a spring-loaded structure on an outer surface the body of the lamp holder, and wherein the power supply substrate comprises a connection portion that contacts the connection terminal at a surface of the power supply substrate that is closest to the connection plate.

22. The power supply module of claim 21, wherein the connection terminal is a spring-loaded plate.

23. The power supply module of claim 21, wherein the connection terminal is a coil.

24. The power supply module of claim 20, wherein the power supply substrate further comprises:
an insulation substrate combined with the connection plate;
a power supply device disposed on the insulation substrate; and
a conductive wiring electrically connected to the power supply device, the conductive wiring being exposed from the insulation substrate for coupling to the connection terminal.

25. The power supply module of claim 20, wherein the connection plate further comprises a first coupling portion and the power supply substrate further comprises a second coupling portion capable of combining with the first coupling portion.

26. The power supply module of claim 25, wherein the first and the second coupling portions comprise a coupling protrusion and a coupling hole.

27. The power supply module of claim 20, further comprising a coupling member combining the connection plate with the power supply substrate.

28. The power supply module of claim 27, wherein the coupling member comprises a screw.

29. The power supply module of claim 27, wherein the coupling member comprises a clip pressing together the connection plate and the power supply substrate.

30. The power supply module of claim 27, wherein the coupling member comprises an adhesive tape disposed between the connection plate and the power supply substrate.

31. The power supply module of claim 12, wherein the body of the lamp holder further comprises a first coupling portion and the power supply substrate further comprises a second coupling portion combined with the first coupling portion.

32. The power supply module of claim 31, wherein the first and the second coupling portions comprise coupling protrusions or coupling holes.

33. The power supply module of claim 12, wherein the body of the lamp holder is disposed adjacent to the connection portion of the power supply substrate.

34. The power supply module of claim 12, wherein the body of the lamp holder further comprises:
a lamp support groove formed at an upper portion of the body, the lamp support groove guiding an end portion of the lamp; and
a receiving space exposing the power supply terminal.

35. The power supply module of claim 34, wherein the power supply terminal comprises a first connection terminal and a second connection terminal disposed to hold a lamp lead, and wherein the lamp holder comprises a holder cap inserted into the receiving space, the holder cap maintaining contact between the first and the second connection terminals and the lamp lead.

36. A backlight assembly comprising:
a receiving container including a plate with openings;
lamp holders inserted into the openings, each of the lamp holders coupled to a lamp and having a body and a power supply member, the power supply member including:
a connection terminal fixed to the plate and exposed on a first surface of the plate; and
a power supply terminal exposed on a second surface of the plate to hold an electrode of the lamp in place; and
a power supply substrate disposed on the plate, the power supply substrate including a connection portion making contact with the connection terminal.

37. The backlight assembly of claim 36, wherein the power supply substrate comprises:
an insulation substrate; and
a conductive wiring partially exposed on the insulation substrate to provide the connection portion.

38. The backlight assembly of claim 37, wherein the insulation substrate comprises fixing holes for receiving the lamp holders, and wherein the connection terminal contacts the connection portion disposed on a surface of the insulation substrate.

39. The backlight assembly of claim 37, wherein the insulation substrate comprises fixing portions for coupling to the lamp holders, and the connection terminal contacts the connection portion disposed on one of the fixing portions.

40. The backlight assembly of claim 37, further comprising a connection plate disposed between the bottom plate and the insulation plate, the connection plate including fixing holes where the lamp holders are inserted, wherein the connection portion that is formed on a surface of the insulation substrate contacts the connection terminal exposed on the connection plate.

41. The backlight assembly of claim 37, wherein the body of each of the lamp holders further comprises fixing hooks preventing the lamp holders from separating from the openings.

42. The backlight assembly of claim 37, further comprising:
a side mold covering the lamp holders; and
an optical sheet unit disposed on the side mold to improve characteristics of light emitted by the lamps.

43. A display device comprising:
a power supply substrate providing a voltage;
a plurality of lamps including lamp tubes and electrodes disposed at end portions of the lamps, wherein each of the electrodes extends to form a lamp lead;
a voltage supply wire electrically connecting the power supply substrate to the lamps in parallel; and
lamp holders coupled to the voltage supply wire, each of the lamp holders having a body and a power supply member to which the voltage supply wire is welded, wherein the body has a lamp support groove in which an end portion of one of the lamp tubes is disposed, and wherein the lamp lead couples one of the electrodes to the power supply member.

44. A display device comprising:
a receiving container including a plate with openings;
a plurality of lamps disposed on the plate, the lamps having electrodes;
lamp holders inserted into the openings, lamp holders including connection terminals fixed to bodies of the lamp holders and exposed at a first surface of the plate, the lamp holders further including power supply terminals exposed at a second surface of the plate and coupled to the electrodes;
a power supply unit including fixing portions and connection portions, wherein the fixing portions are coupled to the lamp holders and the connection portions contact the connection terminals; and
a display panel disposed on the lamps to display an image using light emitted by the lamps.

45. The display device of claim 44, wherein the power supply unit further comprises:
an insulation substrate having the fixing portions; and
a conductive wiring partially exposed from the insulation substrate to provide the connection portions.

46. The display device of claim 44, wherein the power supply unit further comprises:
a power supply substrate having the connection portions; and
a connection plate disposed between the power supply substrate and the plate, the connection plate including the fixing portions.
